(19) United States
(12) Patent Application Publication
(10) Pub. No.: US 2007/0039007 A1
(43) Pub. Date: Feb. 15, 2007

(54) Virtual mind

(76) Inventor: Jeffrey J. Spicer, London (GB)

Correspondence Address: PEACOCK MYERS, P.C., 201 THIRD STREET, N.W., SUITE 1340, ALBUQUERQUE, NM, 87102, US

(21) Appl. No.: 11/321,881

(22) Filed: Dec. 28, 2005

Related U.S. Application Data
(63) Continuation-in-part of application No. 10/848,804, filed on May 18, 2004.
(60) Provisional application No. 60/640,128, filed on Dec. 28, 2004.
(60) Provisional application No. 60/646,960, filed on Jan. 24, 2005.
(60) Provisional application No. 60/647,131, filed on Jan. 25, 2005.

(51) Int. Cl. G06N 3/02

(52) U.S. Cl. 719/310; 715/764; 706/15

(57) ABSTRACT

Virtual Mind is a native a Consumer and/or Provider Processing system invented for creating, delivering, presenting, manipulating and managing by a Consumer or Provider Generically defined scaled Processes. The Process is preferably specified in XML and is of any type, dynamically created, and asynchronously delivered to any workspace instance.

### CROSS-REFERENCE TO RELATED APPLICATIONS

This application is a continuation-in-part application of U.S. patent application Ser. No. 10/848,804, entitled “Web Form Host, to Jeffrey J. Spicer, filed on May 18, 2004, and the specification thereof is incorporated herein by reference.

This application claims priority to and the benefit of the filing of U.S. Provisional Patent Application Ser. No. 60/646,960, entitled “Web Form Host Controlled By Voice”, filed on Jan. 24, 2005, and the specification thereof is incorporated herein by reference. This application also claims priority to and the benefit of the filing of U.S. Provisional Patent Application Ser. No. 60/647,131, entitled “Virtual Mind”, filed on Jan. 25, 2005, and the specification thereof is also incorporated herein by reference. This application also claims priority to and the benefit of the filing of U.S. Provisional Patent Application Ser. No. 60/640,128, entitled “Web Form Host Controlled By Voice Recognition”, filed on Dec. 28, 2004, and the specification thereof is also incorporated herein by reference

### INCORPORATION BY REFERENCE OF MATERIAL SUBMITTED ON A COMPACT DISC

A compact disc appendix containing computer program code listings pursuant to 37 C.F.R. 1.52(e) was submitted with U.S. patent application Ser. No. 10/848,804 and is hereby incorporated by reference in its entirety. A second compact disc appendix is included containing computer program code listings pursuant to 37 C.F.R. 1.52(e) and is hereby incorporated by reference in its entirety. The second compact disc includes three files and is approximately 21 KB. The files included on the second compact disc are listed in the root directory of the compact disc. The following are the files on the second disc: TEWS4.xsd, 3 KB, Jan. 25, 2005; Consumer.xsd, 2 KB, Jan. 24, 2005; Example.xsd. 16 KB, Jan. 24, 2005.

### COPYRIGHTED MATERIAL

© 2004-2005 Jeffrey J. Spicer. A portion of the disclosure of this patent document and of the related applications listed above contains material that is subject to copyright protection. The owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention (Technical Field)

A system natively defined and structured by an exposed structured Universal Type—Universal Leaf Processing Type—that relates all physical and metaphysical Definitions, Interactions and Processes from scaled the Leaf Type to the Universal Type that allows all Process Definitions, Functions and Interactions to be known and interacted with.

2. Description of Related Art

Context of the Invention

The key to manipulating or predicting process interactions is in being able to relate the differently type processing information. Relating information requires a common message format. This is apparent in the impact that XML has had on Computer Information Systems.

The systems generic ability to use Generic processing units removed the need for custom Process implementation and Normalized Process driven processing. This Normalization spoke of a new paradigm, an underlying XML of all process interaction that indicated a structuring to all process interaction.

The New Paradigm thus exposed a Processing Leaf definition schema that defined all processes their functionality and processing interactions. The schema was scaled for concurrency—by an order—each order of scaling called a Dimension and Delimitation introduced as dimensional indicators. The schema s mathematical representation is that of a CUBE as the interactions in three planes.

Further examination of the CUBE structure mathematically, exposed the definitions to be harmonic creating—as the unit component—a Dimensioned Harmonic CUBE.

Life Cell

The Leaf Schema Dimensionally by its definition requires that all consistent parts be present and that through combinations of order, typing and complexity composes all things. Thus at the leaf all things must contain the constituent components of life processes by definition. Thus the base Dimensioned Harmonic Processing unit component referred to in this document is termed the Life Cell or Life CUBE.

The Life Cell or Life CUBE Processes is the single entity that is defined as the Universal Dimensioned Harmonic Processing Unit, and is therefore the common message delimiter. It is a scaled, differently typed version of itself Its typed scaled interactions lead to an un-solvable complexity of Process Systems or Life Systems. This we experience by examining the components, processes and cycles of Process Systems or Life Systems be they Life and Death or Climate Change.

Natively defined by the Universal Processing Leaf Schema, Virtual Mind has exposed a Process defined and driven pre-ordered structured Universe. Examination of Virtual Minds Native Architectural Definition, Functioning and Processing exposed the Leaf definitions of the Universal Leaf Schema structure and through analysis of this Universal Leaf Schema and its recursive scaling and homogeneous definitions has exposed The Life Cell as the Universal Dimensioned Harmonic Processing Unit.

Thus a Harmonic Dimensioned Universal Structuring has been exposed and is encapsulated in the mathematical embodiment of a Universal Equation of Life and a process structuring of a CUBE and its mathematical progressive and parametric adjusted derivatives and through the application of the Universal Equation of Life and Dimensional and Genre navigation variations we may now participate in all inherent and interactive Dimensional Harmonic processes however expressed, in text, field generation, hieroglyphics indeed in any system that is defined as Harmonic and Dimensional and in accordance with the Universal Type, which is all systems from the Leaf to the 27 Universal Groups.

The system is embodied in a development system Omnis Studio that for the update has been re-defined Harmonically and Dimensionally and all the constituent components Harmonically Dimensionally expressed to support the new Harmonic Dimensioned system Virtual Mind.

### DESCRIPTION OF RELATED ART

Overview

The exposure of a structured defined universe has allowed all processes to be reduced to a single Leaf component that can be manipulated through the CUBE structuring to allow all processes to be related. The additional exposure of a pre-ordered structure emphasis's that if all definitions are known for definitions, functions and processes that the interactions are predictable. Thus processes may be manipulated to cause known interactions and results.

Examination of the process tree exposes a duality of Dimensional changes, those of the dimension and metaphysical or inter-dimensional. Thus all processes have components that have values in both. Thus a reaction such as a Nuclear reaction will release large amounts of unaccounted for inter-dimensional energy that can cause the early dimensioning of scaled components of the processing unit. i.e. a component of Global Warming.

The uniformity of definition by delimitation means that all processes may be mapped to one Universal Harmonic Dimensioned map. Process interaction could therefore be predicted and manipulated, however, these unaccounted for Inter-dimensional energies have interactions that cannot be measured and so add unpredictability to process examination, interaction and manipulation. (No known cure)

As the Universe is predefined the interactions are predictable. If the process interaction inputs from these inter-dimensional processes were known and could be used alongside the dimensional manipulation, than complete predictability of process interaction would be achieved.

One object of the system is to provide a processing environment that can create, deliver and execute, manage orchestrate and manipulate any complexity of Harmonically and Dimensionally structured Processing CUBES.

One such embodiment of the system Intelligently delivers energy field production for advancement or reduction of Dimensioned Harmonic Energies intelligently altering itself depending on the Consumer response to its last actions so that the desired result is achieved—by dynamically adapting and up-dating its definition, functionality and processing at runtime to manipulate the Consumers Processing according to the Processing requirements of Virtual Mind.

or a target element and a generated electromagnetic field for dimensioning the element

or a cell and a Energy Field for treatment of disease.

or a Stem-Cell and a Energy Field for development or creation of Cell variations

or a dimensional energy adjustment to the resolution of thoughts

or to predict dimensional paths for all desired dimensional energy alterations or scenarios

or to suggest optimizations to current non- harmonic workflow processes and patterns

or to create dimensioned processes from existing non harmonic processes

or to create intelligent ever more dimensioned harmonic solutions.

to manage harmonically defined dimensioned processes to all inter-dimensional transfers or capturing or communications.

The ability to perform these processes successfully by means of prediction means all component processes must be known both physical and metaphysical and so additional Harmonic Dimensioned Information is required to create a integrated process definition map that can be used to predict and manipulate Process interactions.

Processing Information Sources

The Holy Bible

The Holy Bible is a Harmonically coded Dimensioned text that provides Harmonically Defined, Functionlized Processing. And there interactions. Using the text from the Holy Bible and the CUBE paradigm the codes are exposed and thus provide for all Virtual and metaphysical and physical process definitions functionilzations and process to be known and for there effect which cannot be measured currently as they are inter-dimensional or meta physical.

Other Harmonic Dimensioned Examples Defined by the Universal Schema

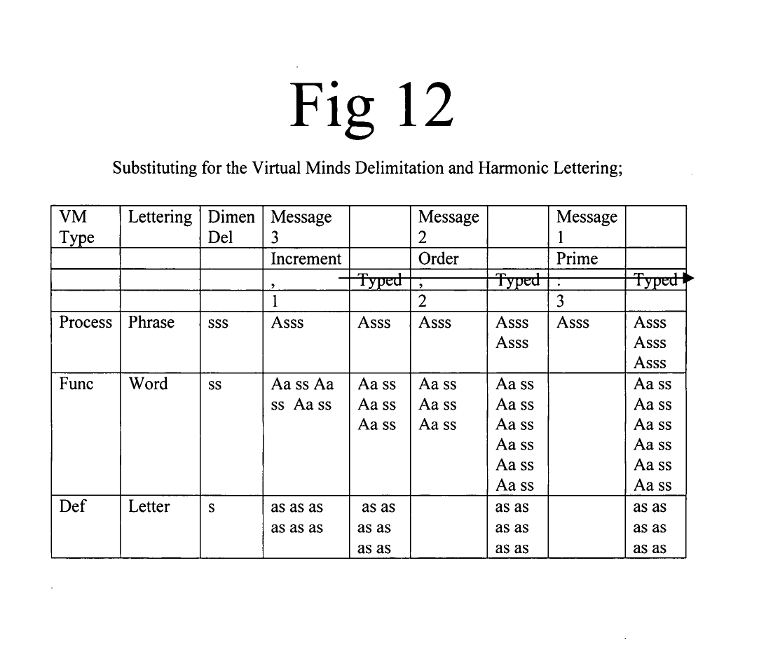

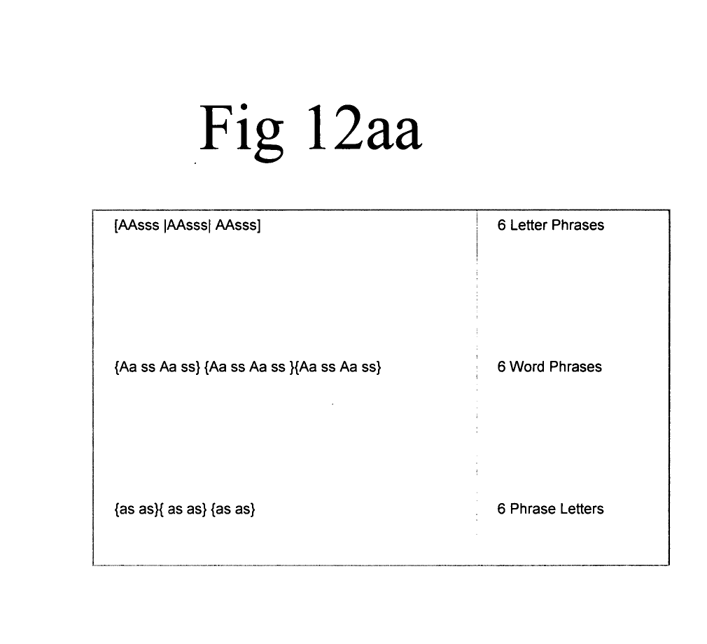

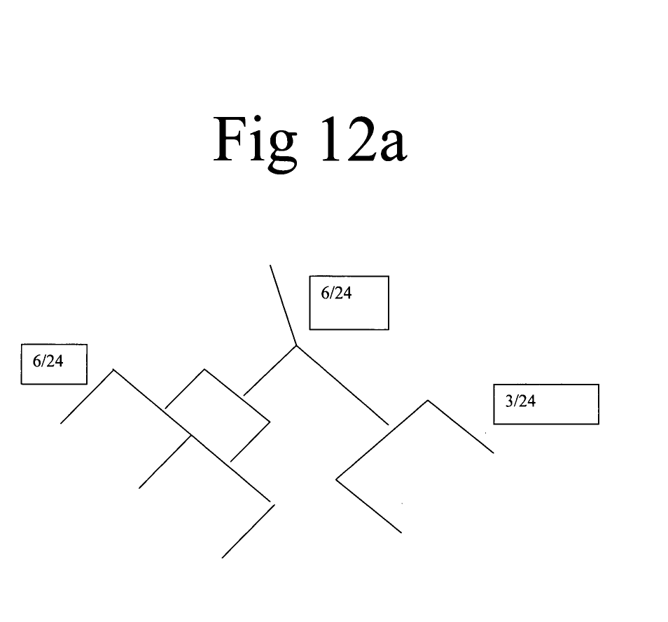

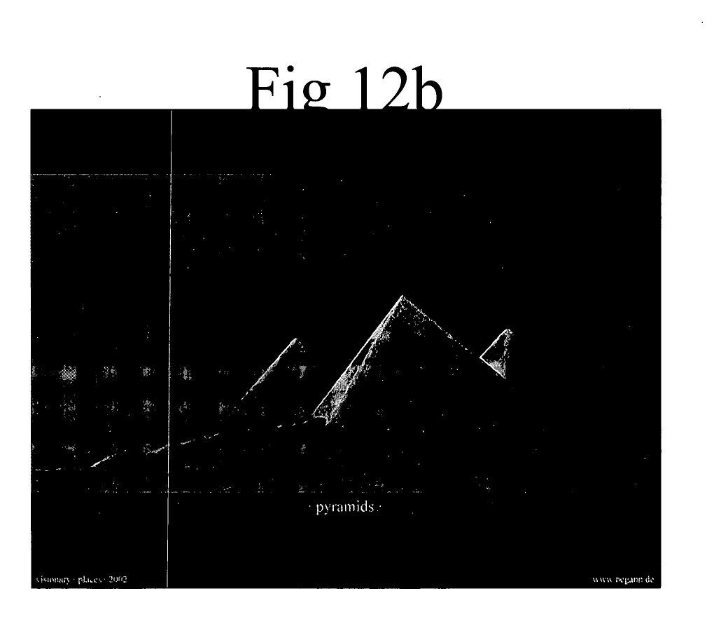

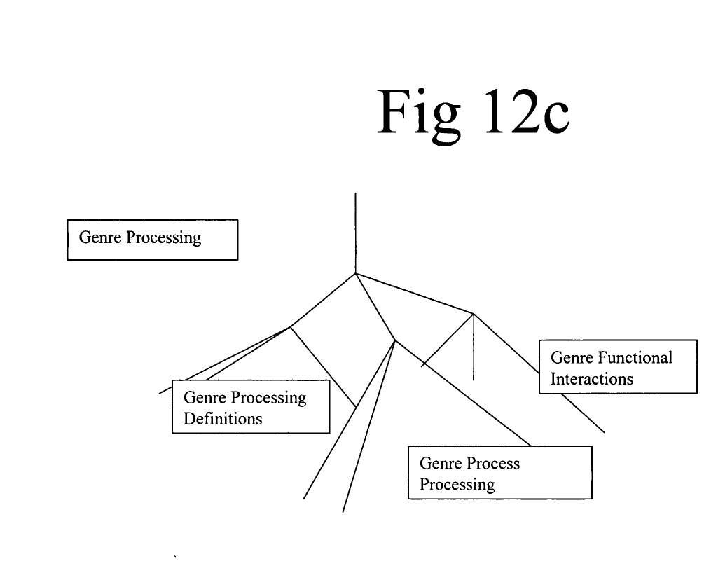

The Pyramids of Egypt FIG. 12b FIG. 12c

Hieroglyphics

The Egyptian Language is a Dimensioned set of symbols that allowed the Egyptians to record and write Harmonic Dimensioned Hieroglyphics

Hieroglyphics structuring, functionalization and expression could be reproduced if the Harmonic Language components are established and functionalized and expressed according to the Universal Schema.

Dimensioning Chambers

The writings on and in the Pyramids would be exposed during cycles of the Sun and the shadows that it cast to reveal a instructional or function set of readings Dimensionally and Harmonically at run-time. The chambers would be constructed as to place them in a energy field in the Pyramid structure to provide Dimensioning energies for all Life purposes. These Life Process ‘activities’ would cross all physical and metaphysical definitions, functions and processes, and for parts of the cycle expose the Pyramid chambers to inter-dimensional processes.

The Daily, Seasonal in Energy and Consumer definition variations and its application to the Pyramids themselves would expose the writings in a number of planes and instructional levels.

Pyramids as CUBE Genres FIG. 12a

Relating all three CUBES for Genre Processing would create 3 harmonic lettering type variations of the three Scaling type combinations of 3 genre Rotation types, Thus if all variations of Genre can be implemented in three Pyramids.

### DEFINITIONS

Process

Dimensional

Delimiter

Scaling

Leaf

Universal

Life Cell

Pyramid

Definition

Function

Process

Process Processing

Map

### BRIEF SUMMARY OF THE INVENTION

VIRTUAL MIND

A self defining system for creating, presenting, manipulating and managing a multiplicity of harmonically based Dimensional CUBES and their processes at run time. It may be self-operating or managed by a remote process. The CUBES are specified in XML and may be of any Type dynamically created, delivered and executed on a remote dimensional platform.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

### DETAILED DESCRIPTION OF THE INVENTION

Overview

System Definitions

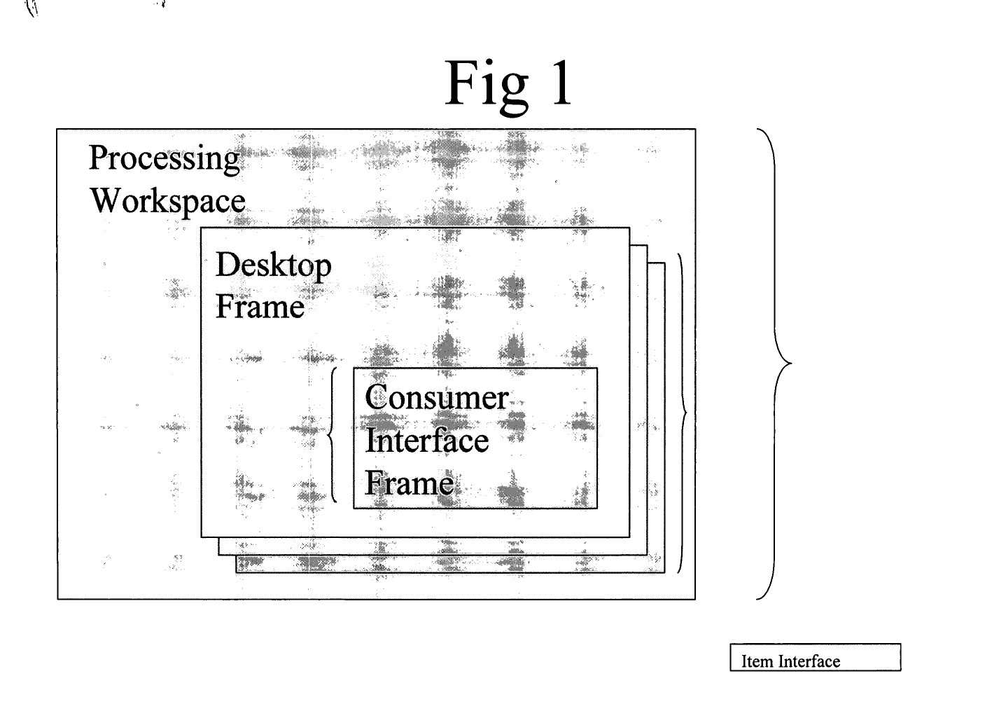

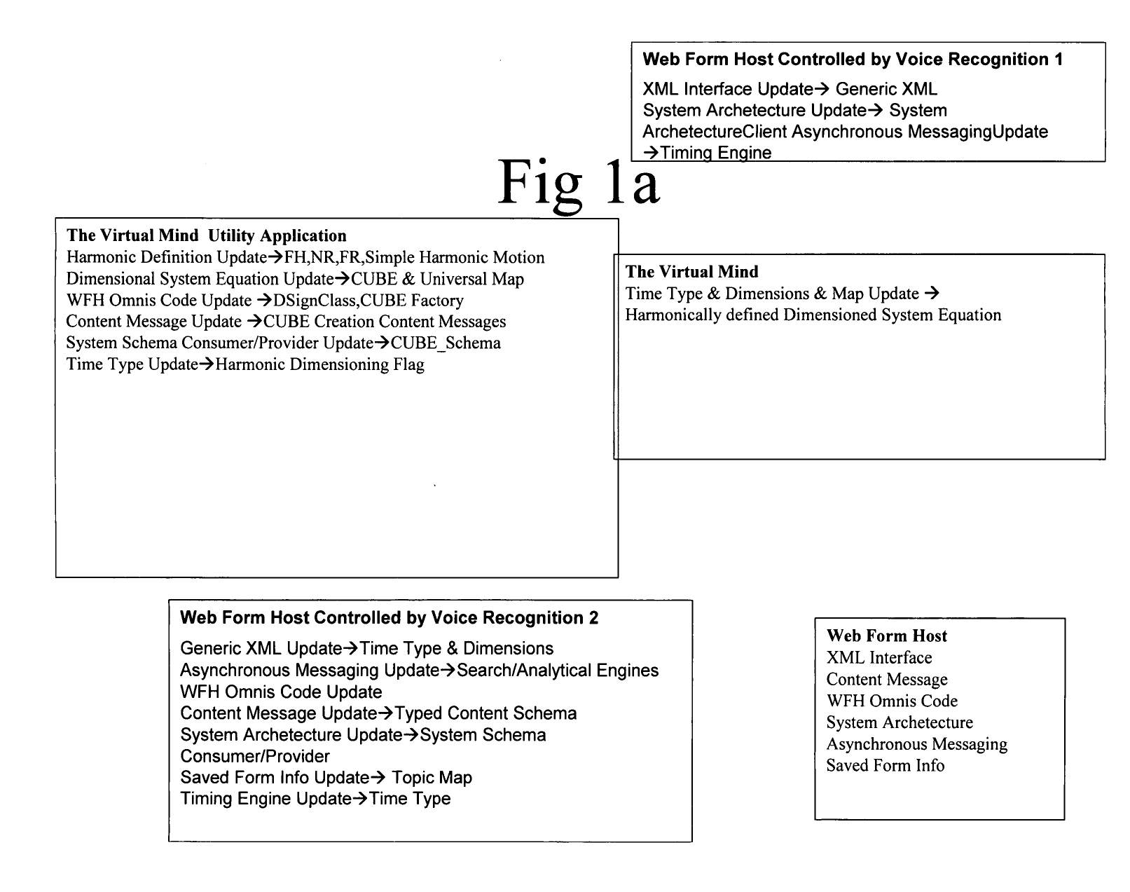

System Architectural Components (FIG. 1)

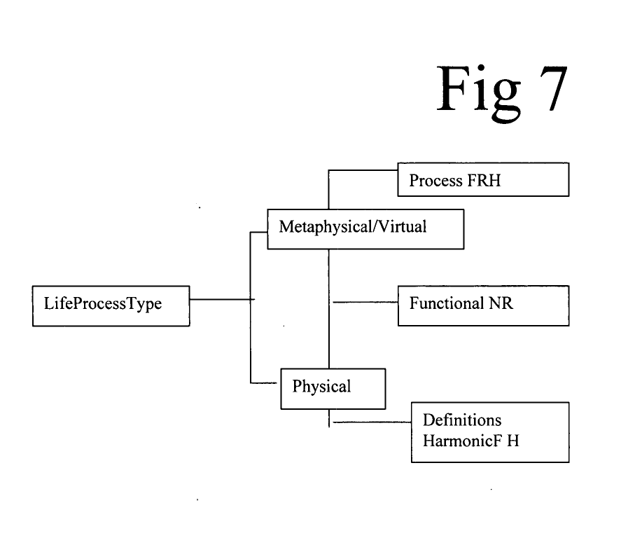

Virtual Mind Schema FIG. 7

The Schema is an Harmonic Dimensioned Update to the Content Message and represents that system defined in accordance with the Universal Type.

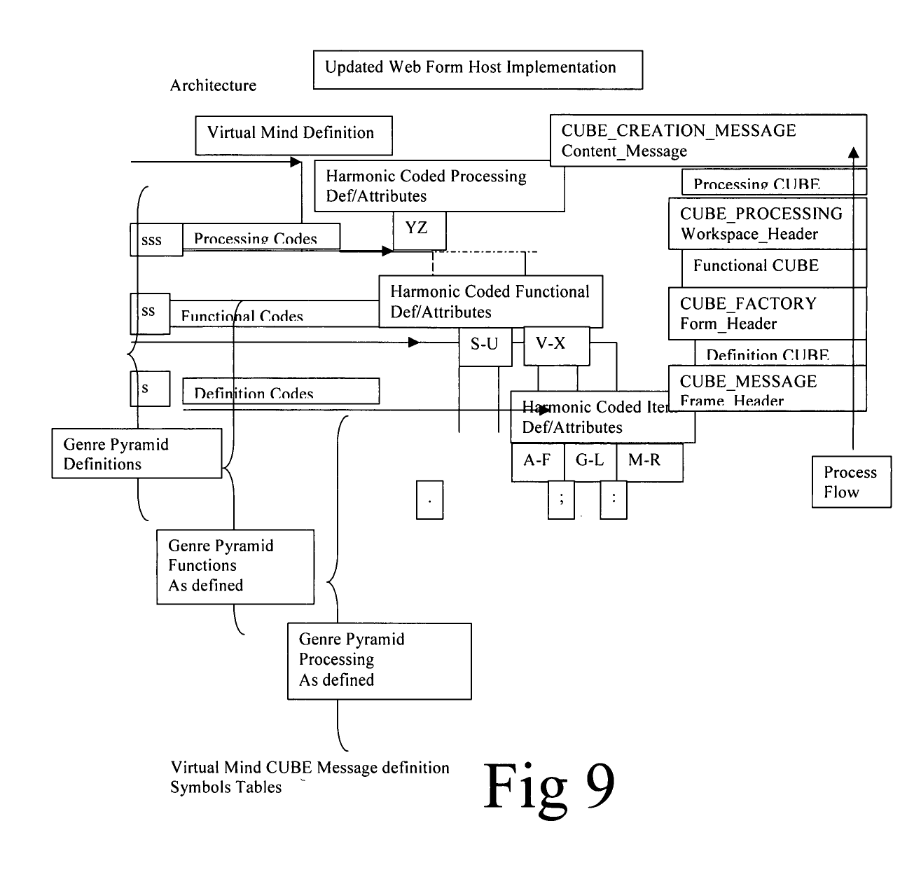

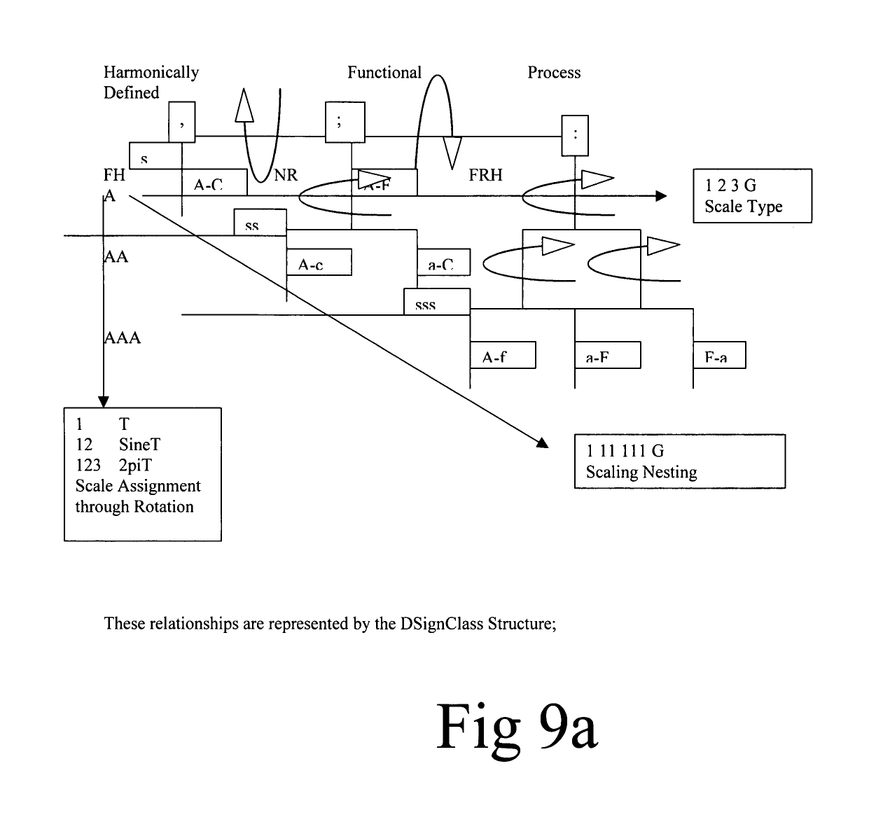

Universal Schema FIG. 9a

The Universal Schema is a Generic representation of the Schema and includes Universal Schema and Delimiter Pairings and Genre Scales

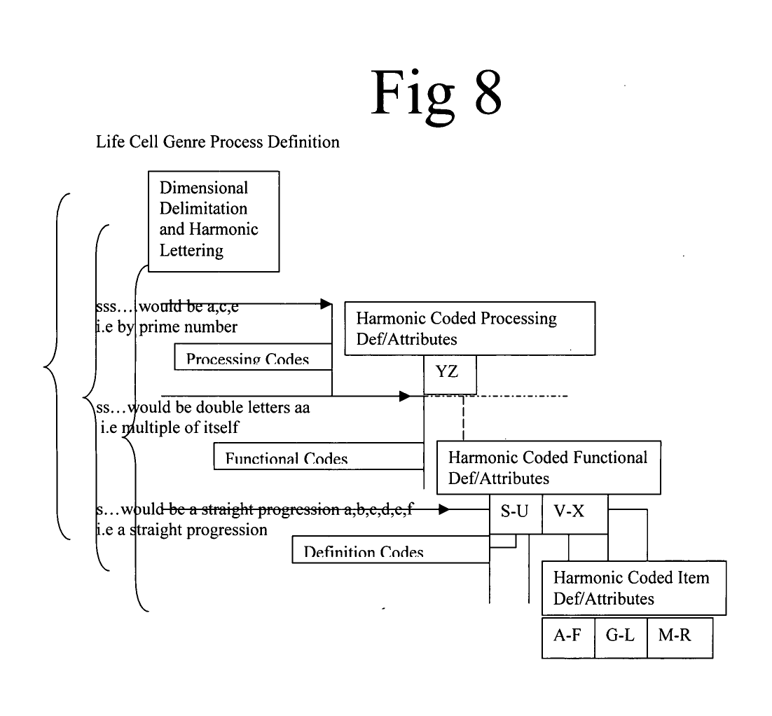

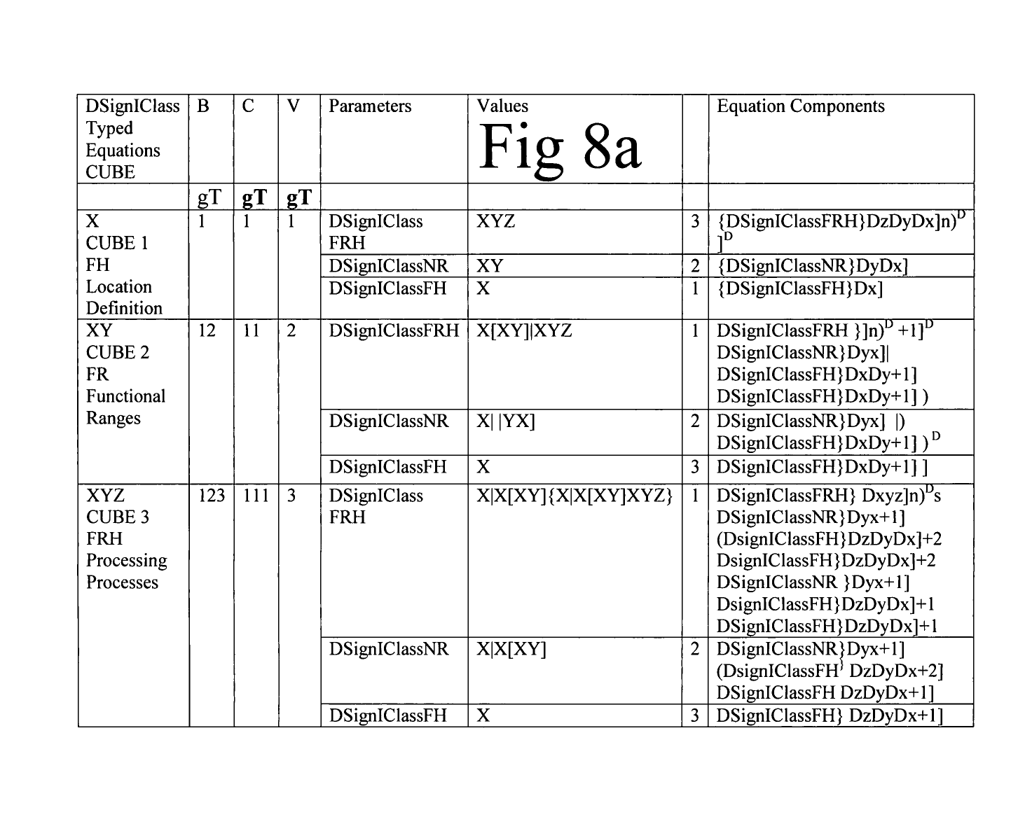

Logical Architecture of Virtual Mind FIG. 8

The Logical representation of the systems generic Architecture

Universal Logical Architecture FIG. 9

The Logical Architecture is based on the system being defined Dimensionally by delimitation and by Genre and by the use of Harmonic coding and delimitation to define Types within the system.

Physical Architecture Embodiment of the DSignClass in Omnis Studio DSignClass FIG. 8

The DSignClass is representative of the Universal Leaf Schema which—typed for definition, functionality and processing—represents all components in the system

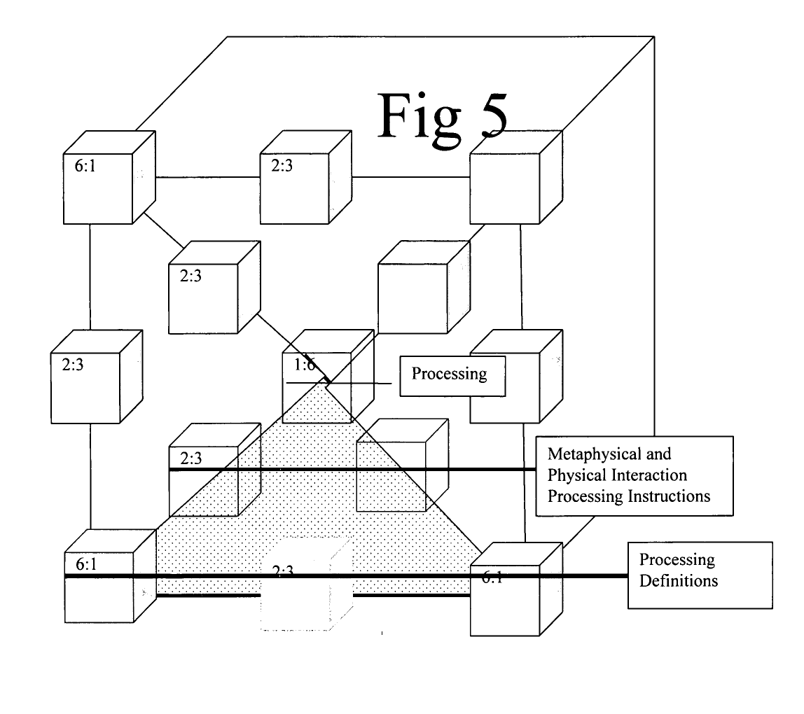

The Life Cell Processing CUBE FIG. 5

The center CUBE has all the process processing information for all the Genres and is the Universal Map of all process interactions. If Harmonically coded and completed it provides all codes for Definitions Functions and Processes for Life. The complete Processing CUBE can be considered to be a Life Cell Process Definition CUBE.

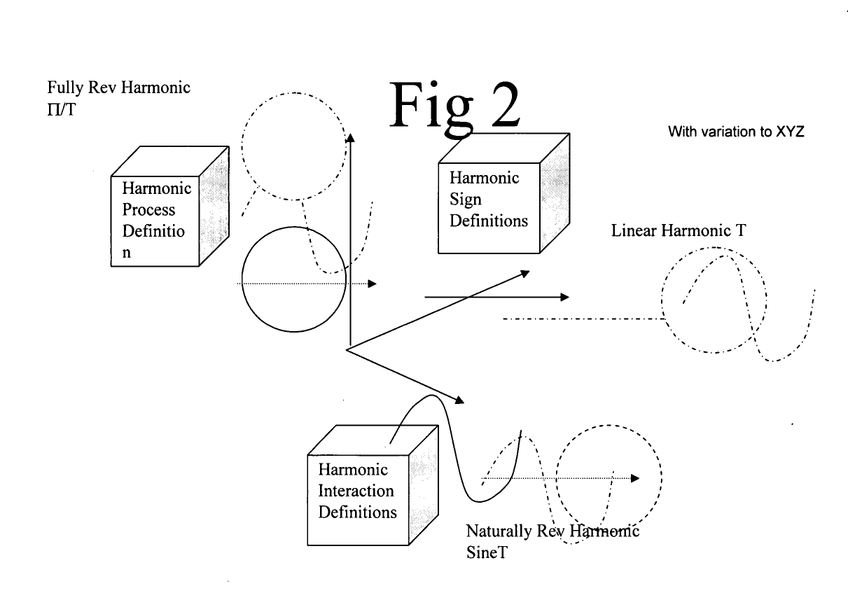

The CUBE FIG. 2

The CUBE is defined by relating the components of Simple Harmonic motion in a Harmonic Unit definition. If variations to an axis are applied to each the CUBEs axis the CUBE becomes a Dimensioned Harmonically defined structure representing Harmonic definitions, Harmonic Interactions, and Harmonic Processes.

The Universal Man

The Universal Map is a CUBE that contains the mapped harmonic Processes identified by their harmonic Identifiers grouped. The map contains the Genres processes and will allow for the visual view of the Harmonic Dimensioned Genres Processes. the Universal Map represents Processes by using Dimensional and Harmonic Indicators Processes may be added combined removed adjusted, dimensioned, reduced, interrogated for there constituent component processes at run time.

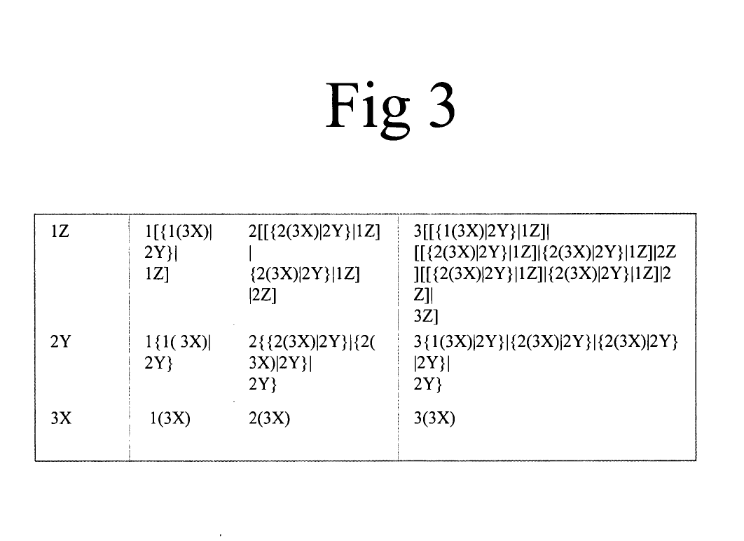

Dimensional Delimitation FIG. 3

The Universal Schema Type expresses Harmonic Dimensionality. The changes in Dimensional values are given through Delimitation Signs which must be related as—and able to be expressed as—a dimensional advancement of its predecessor. So defined they are used as generic placeholders in all CUBE related mathematical and descriptive Dimensional operations.

Typed Equations

Typing Equations are used to turn the static change equations into process enabled equations providing directional flow through the CUBE. They can be seen as equations that represent change through the CUBES processing and if used instead of the static equations re-represent the CUBE as a processing version of itself.

Harmonic Lettering

Harmonic Lettering is used to define harmonically system entities, and delimiters and Processing entities including definitions, functions and processes.

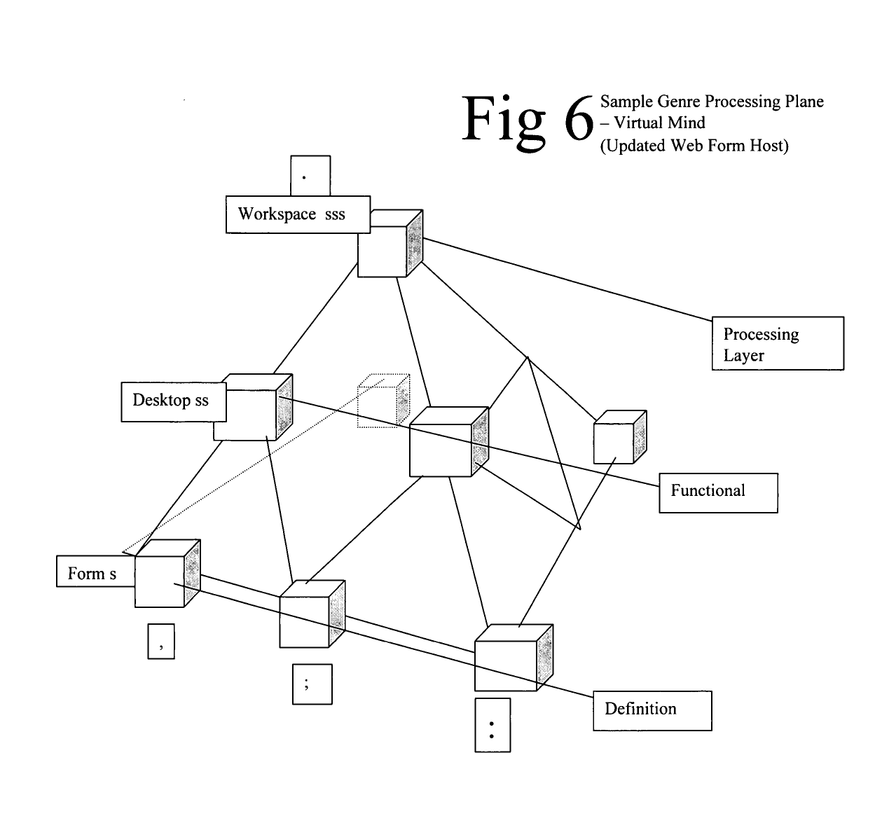

A Genre FIG. 6

This defined Process Flow is one 24^{th} of the CUBEs processing it and is a Processing Genre and is further defined as a Processing Type Plane at the Leaf level and are Harmonically defined by the CUBEs Typed Equations the CUBE can be drawn with Processing planes through the typed equations thus giving 6 Genre Pyramids each with 5 faces.

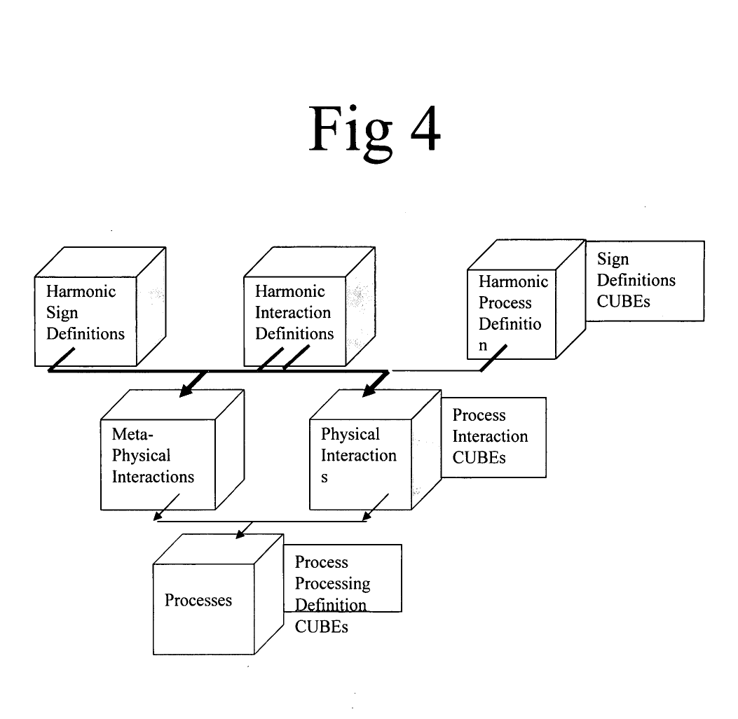

Process Flow FIG. 4

Process Flow is obtained by using the gathered equation components from each CUBE (Typed Equations) that deliver the change. Collecting these change equations, called Typing Equations for the CUBE therefore allowing the CUBEs static definitions to be used as a process enabled definitions and allow the CUBEs architecture to be re-represented as a process flow.

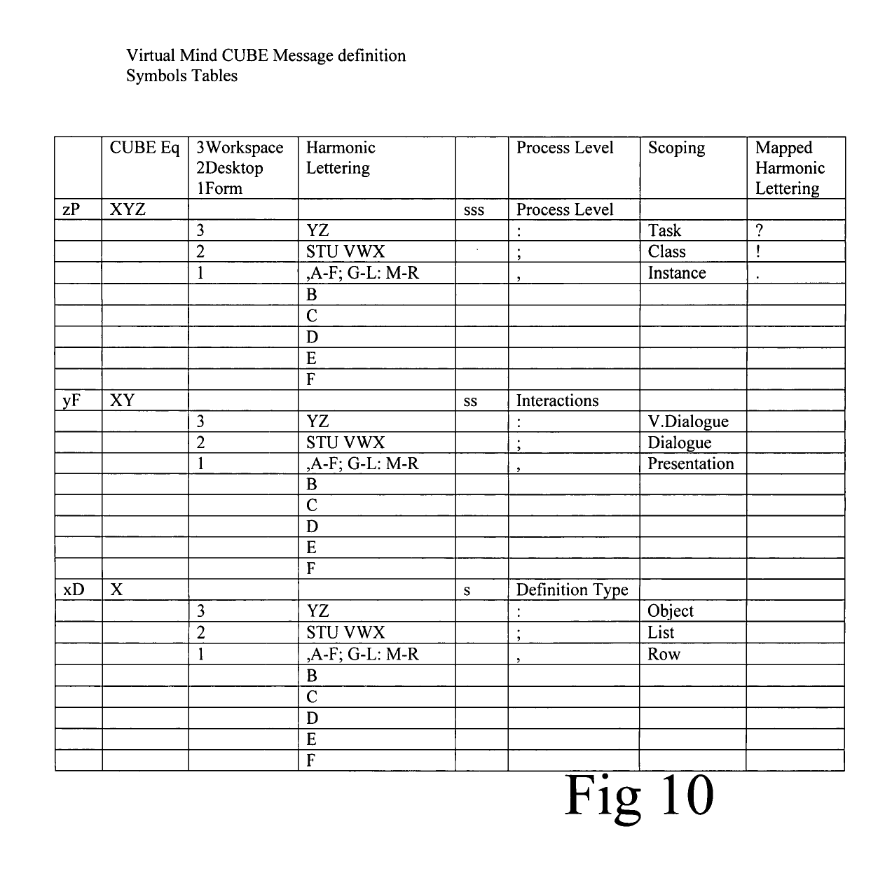

Message Table FIG. 10

The Message table is the Process message definition table allowing the Leaf level Process message structures to be constructed and functionalized through application of delimitation and Harmonic lettering.

Functional Messaging Architecture

Coded Delimited Message Structures

System Creation Message

Functional message

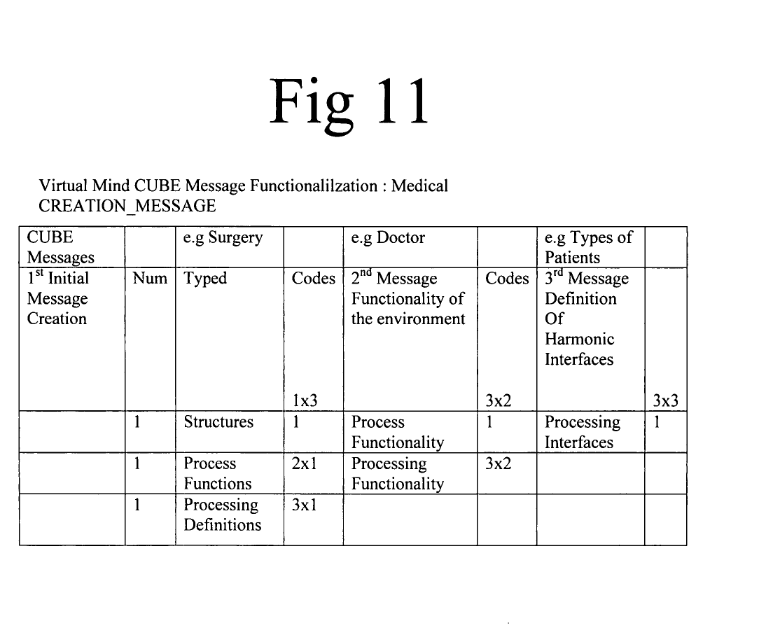

Sample Message FIG. 11

The Sample message is a Generic message that has been used to illustrate the message parts used in creating a process. Each message is defined by the system and functionalized with meaning by the use of the Harmonic codes and Genre typing Delimited Creation Message FIG. 12 FIG. 12aa

Using the system message definition structure and Harmonic and Dimensional components to structure a system creation message which would involve the establishment of the base system components The CREATION_MESSAGE structure is provided by the 3 messages.

Processes

Processing of Messages Architecture

Coded Delimited Message Execution

System Process (FIG. 1a)

Creating New Processes

Updating Processes

The CUBE FACTORY

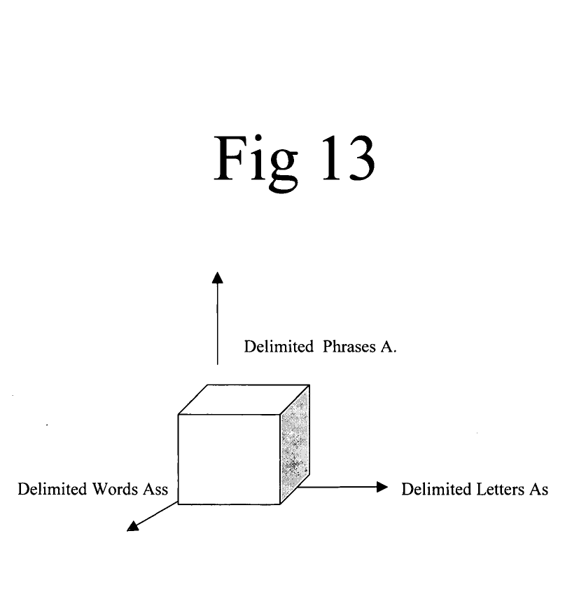

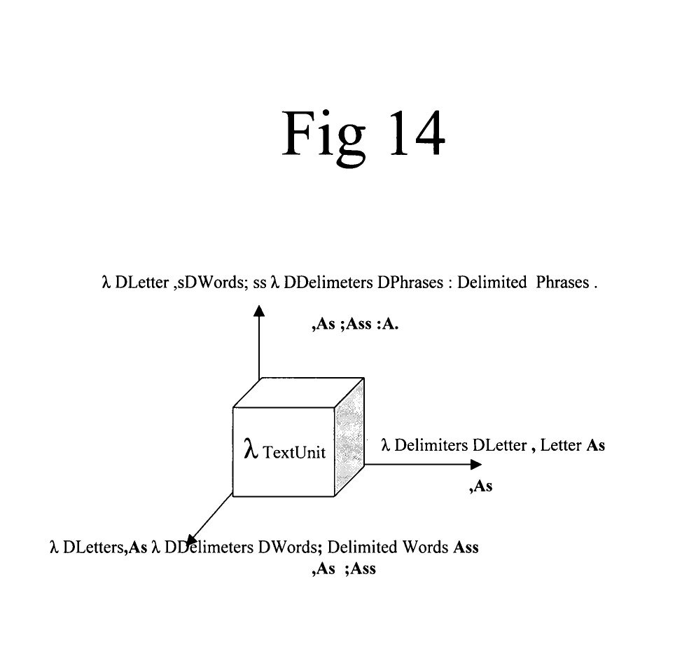

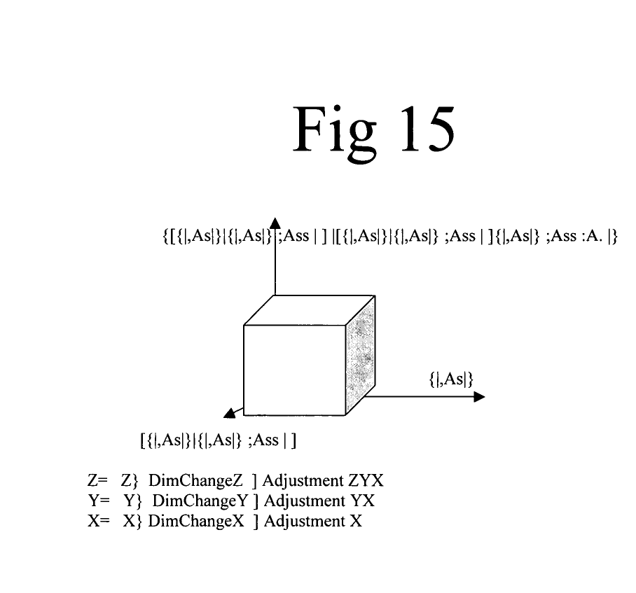

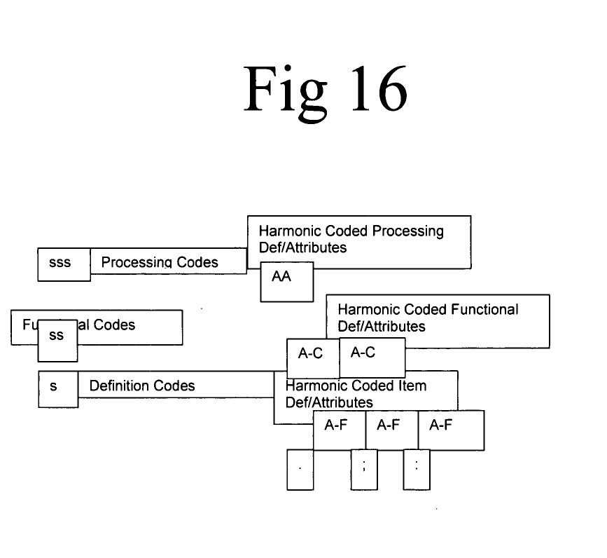

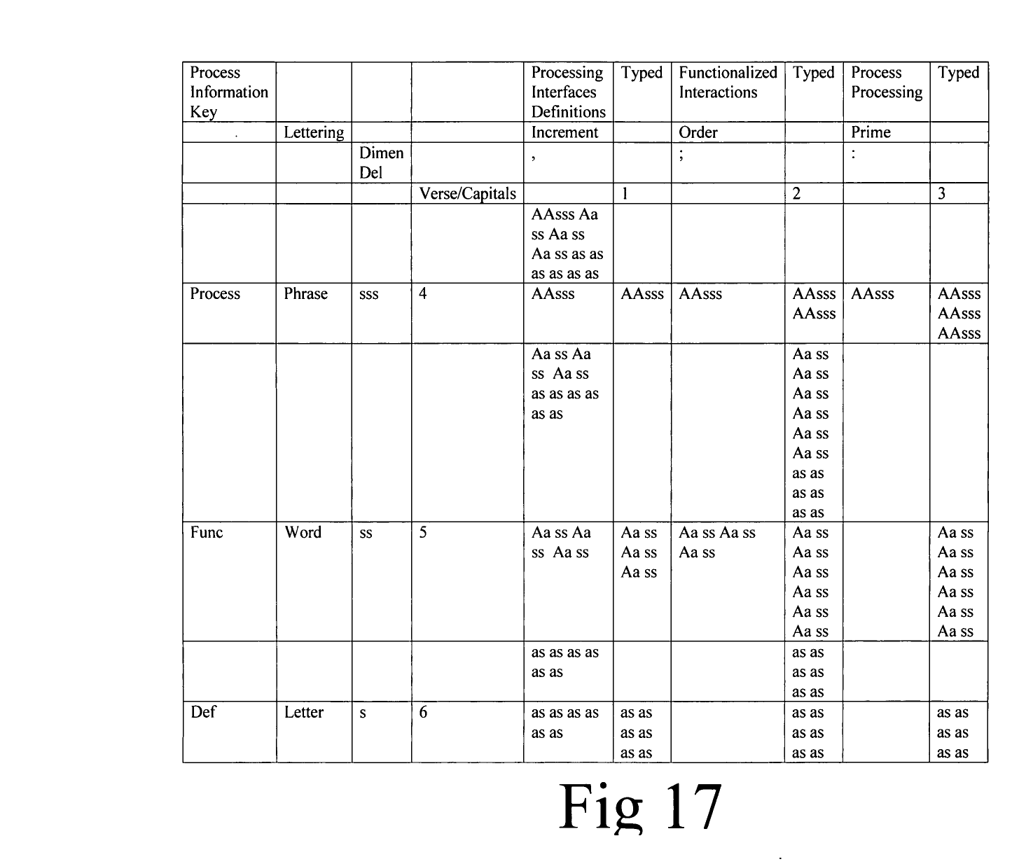

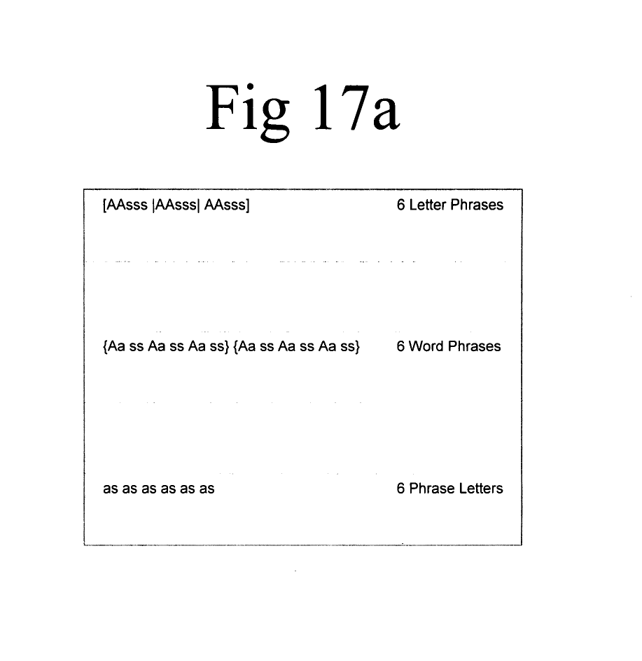

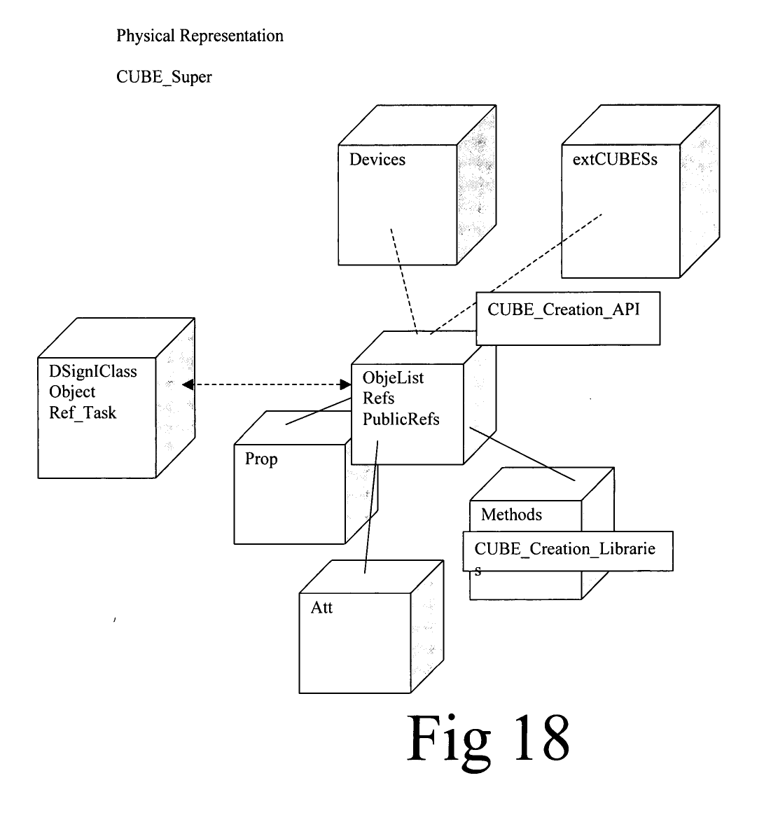

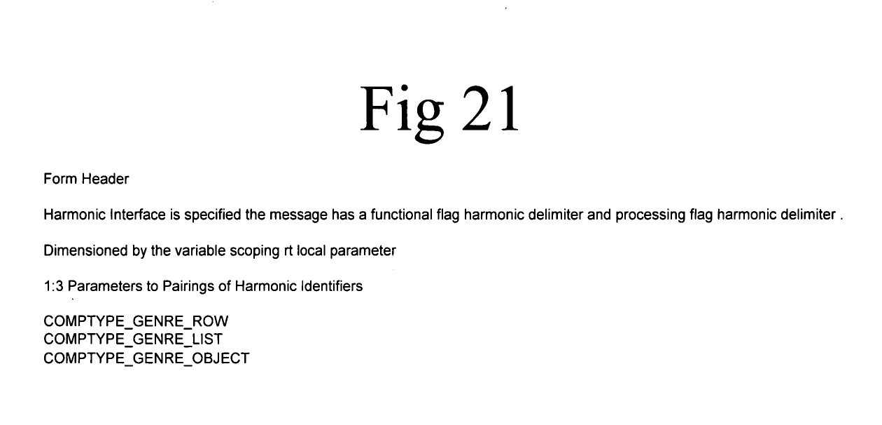

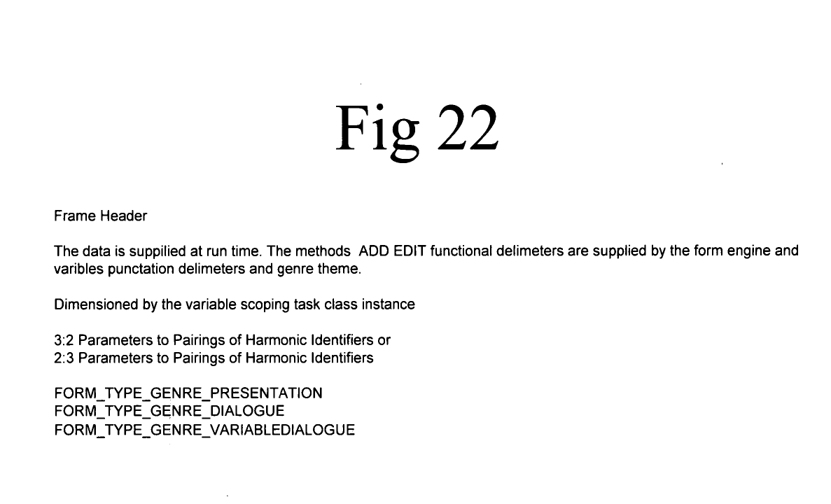

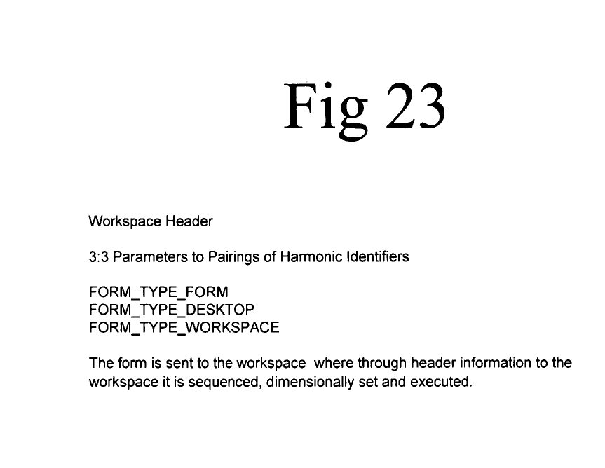

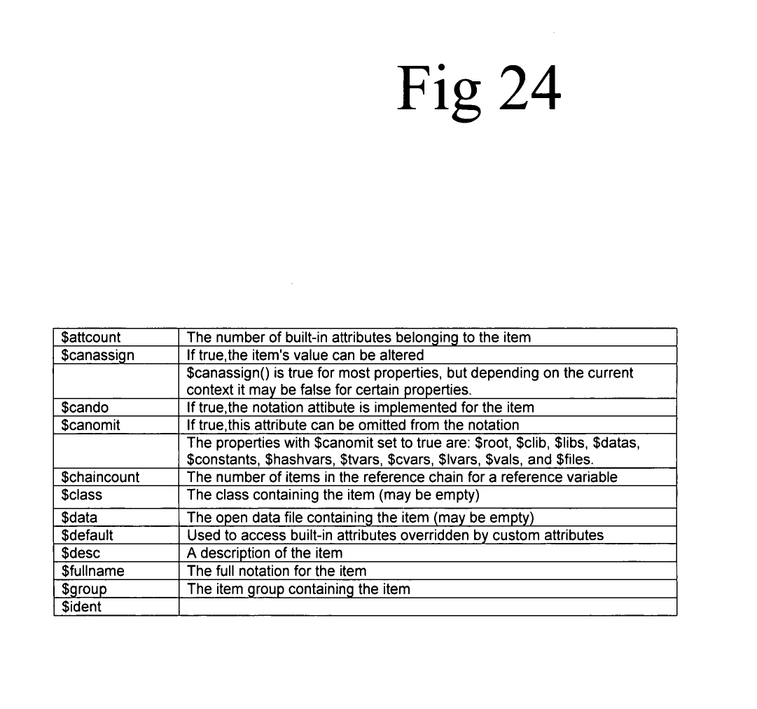

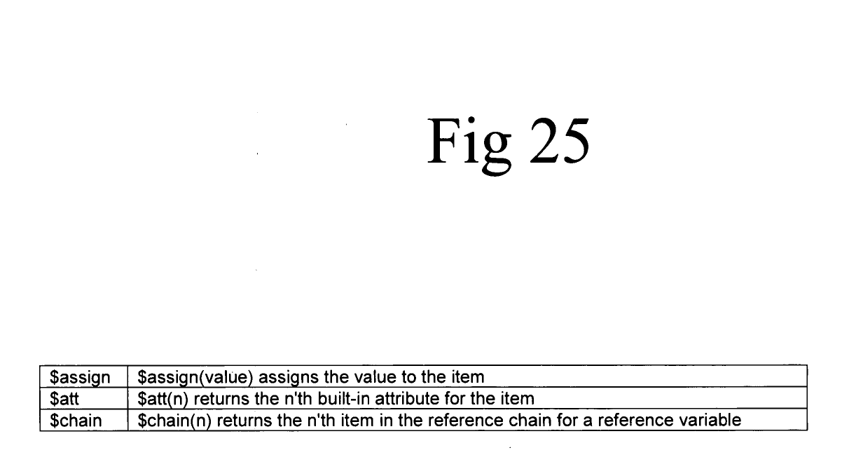

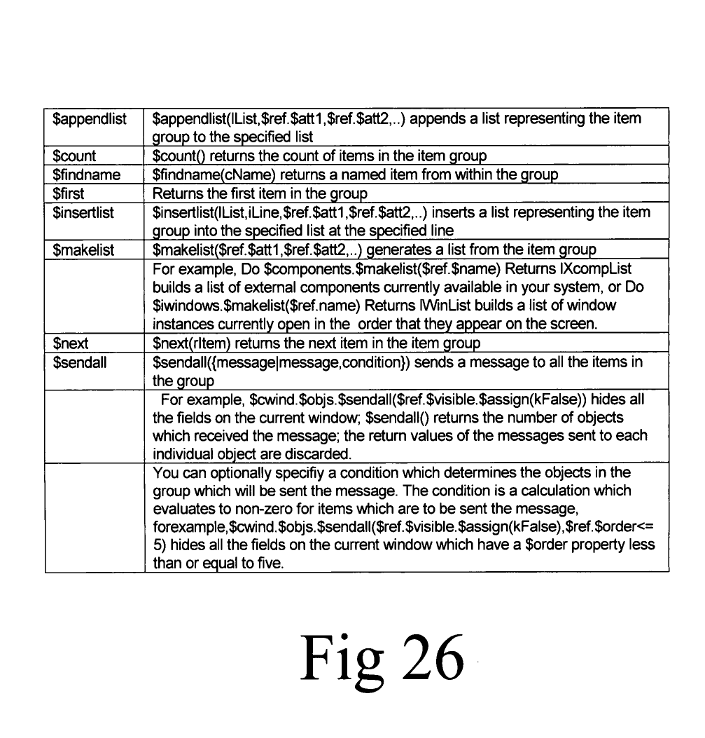

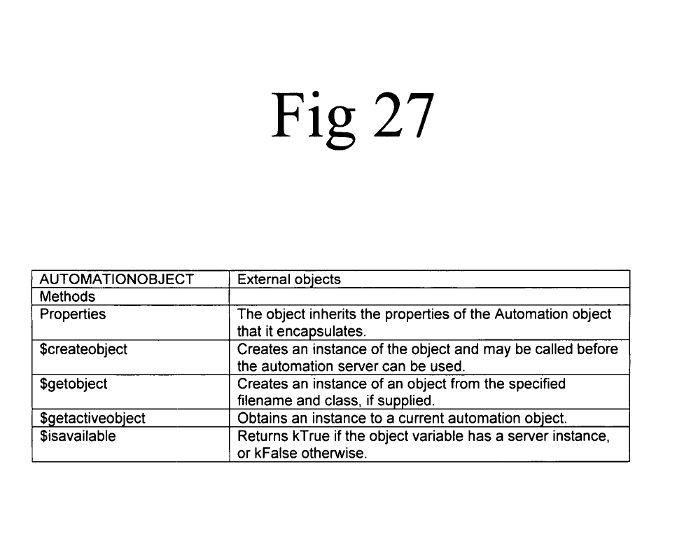

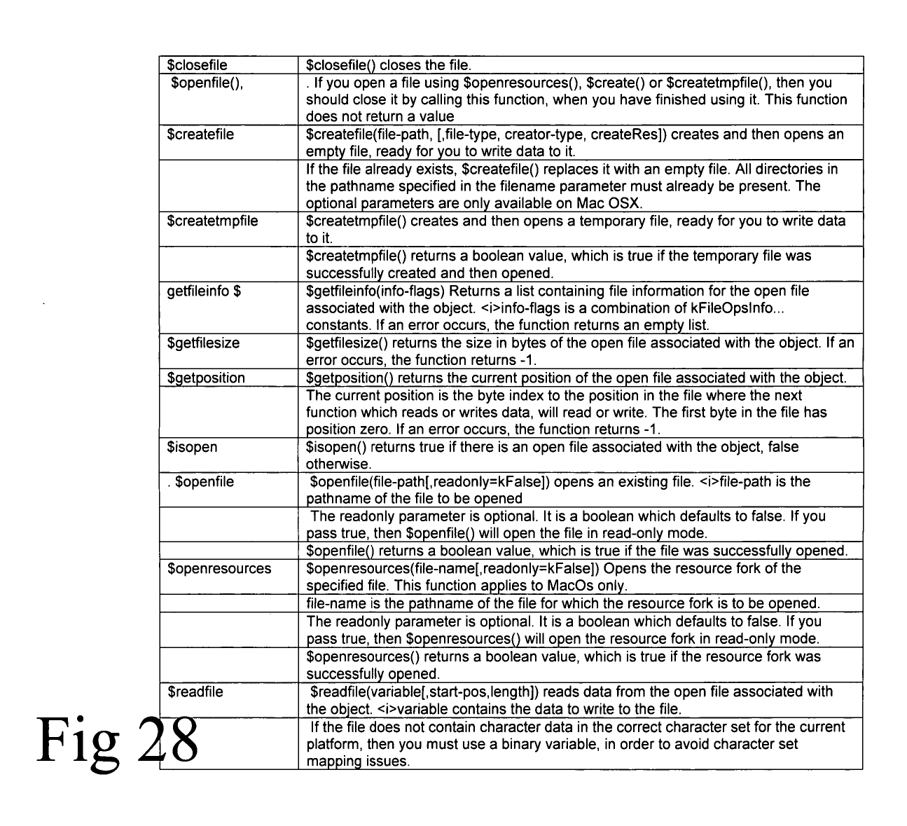

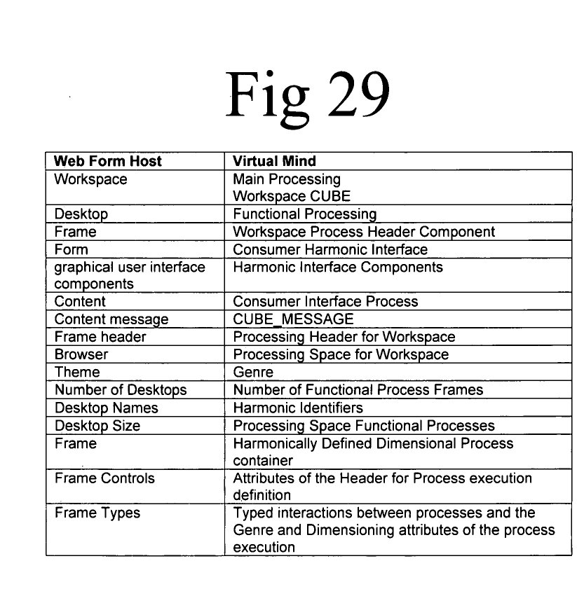

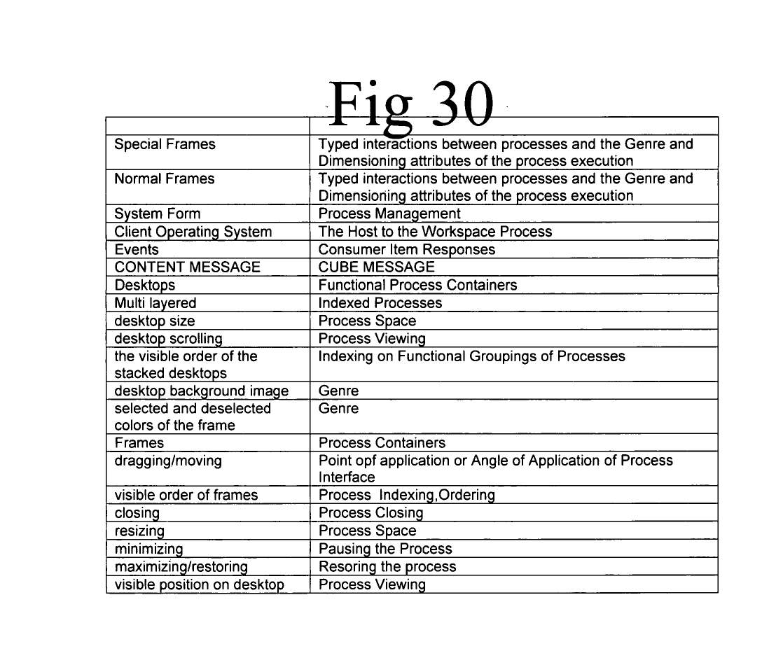

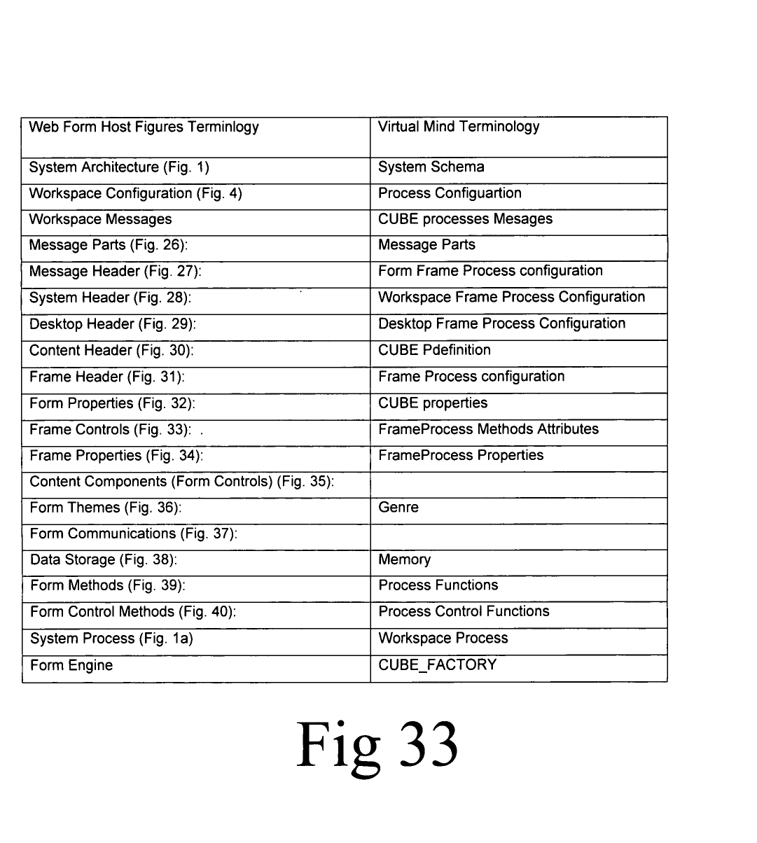

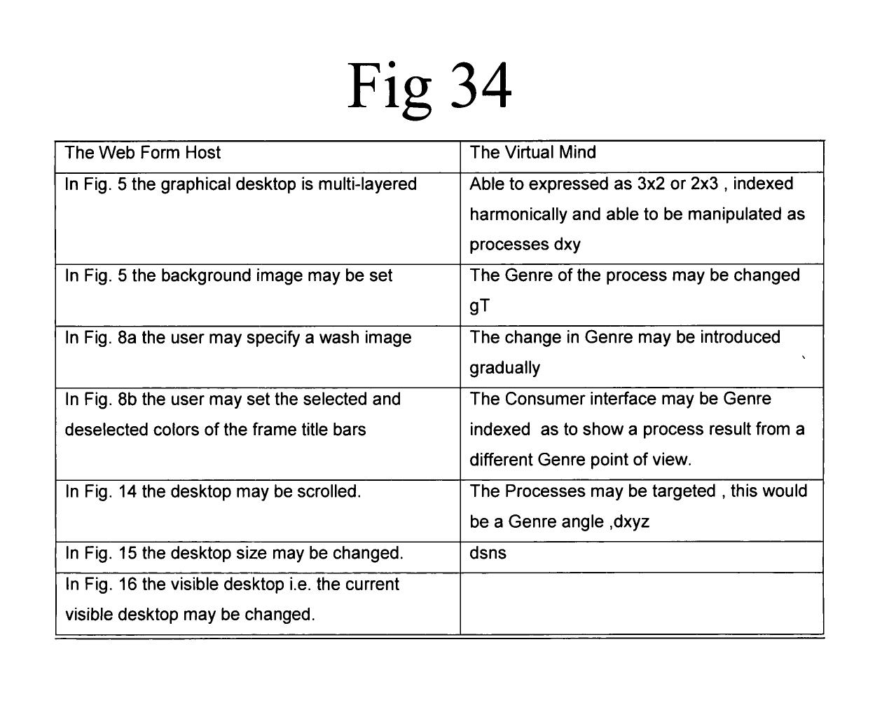

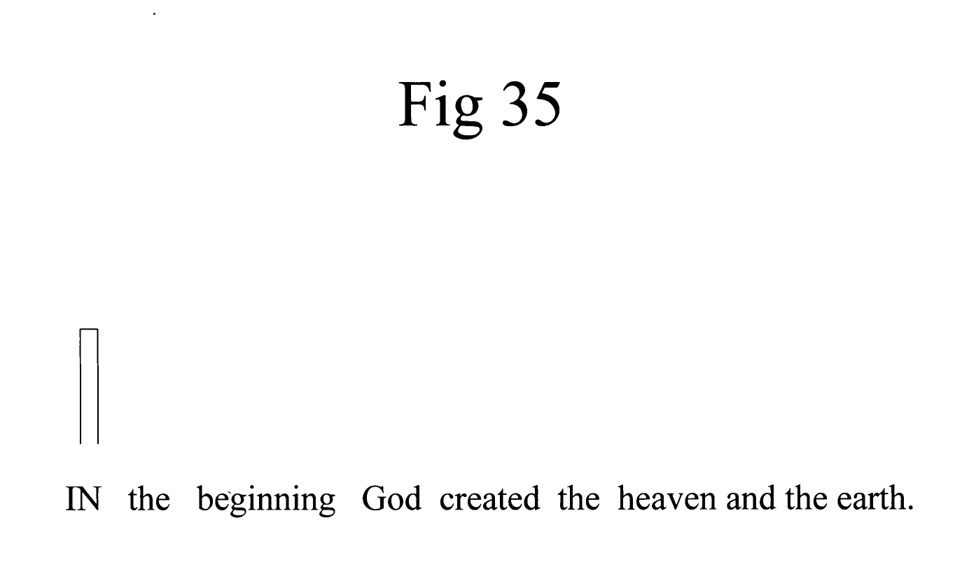

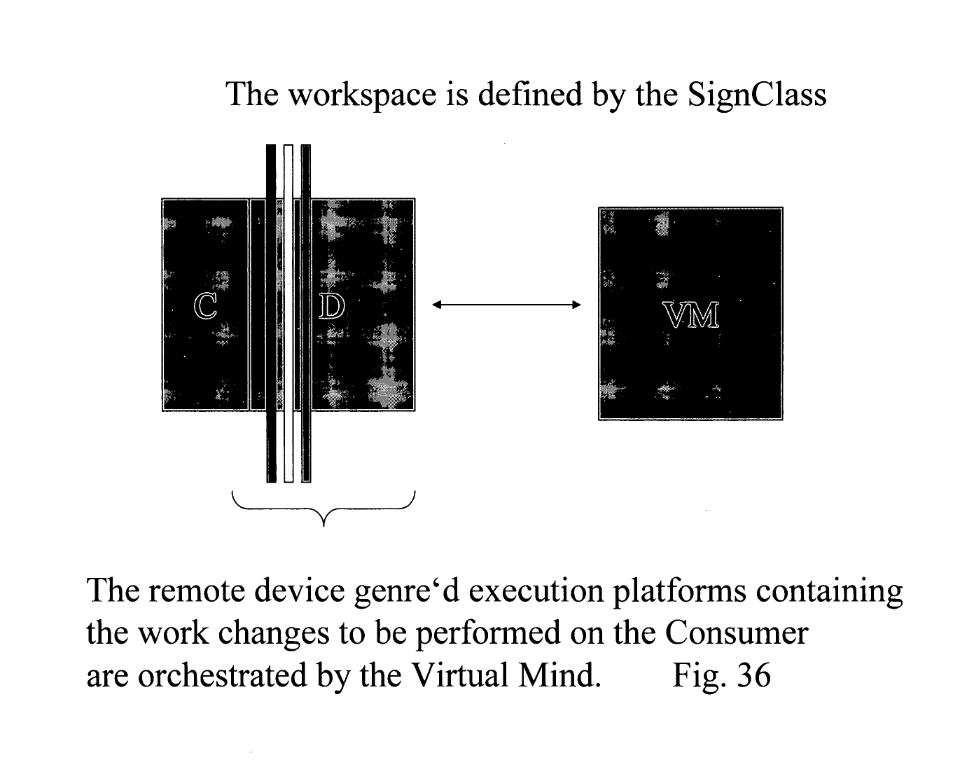

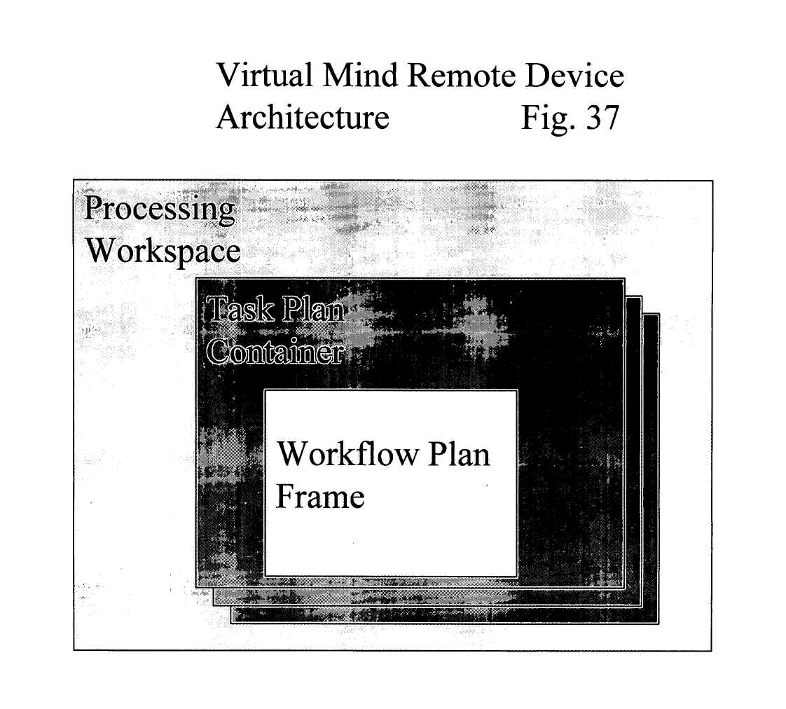

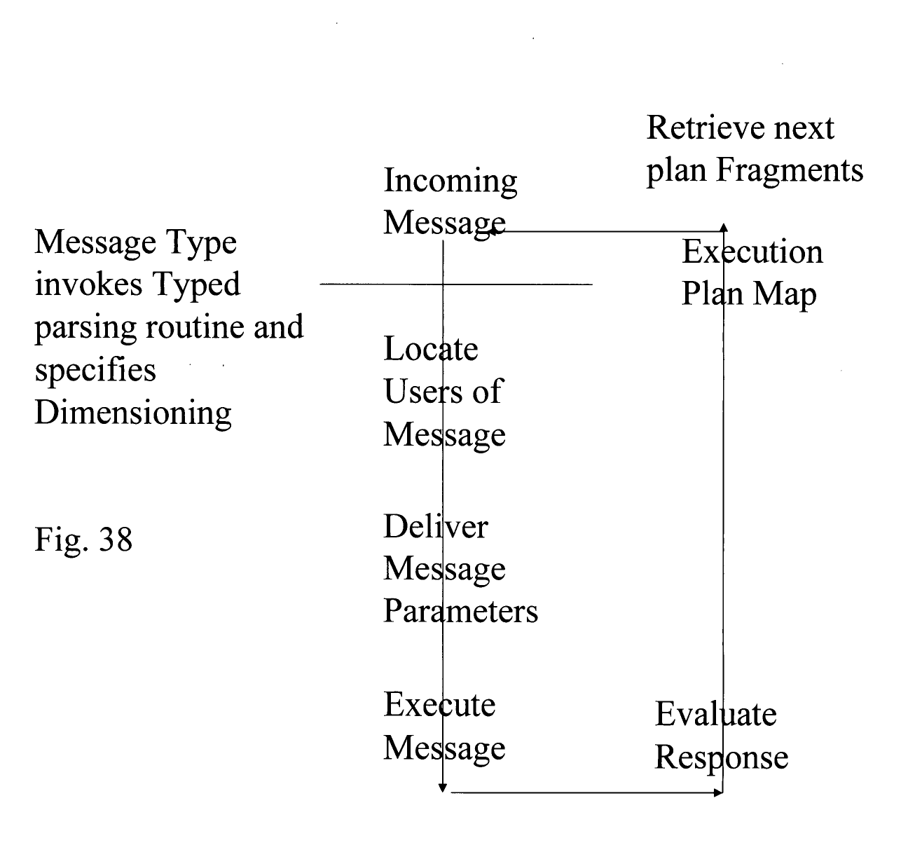

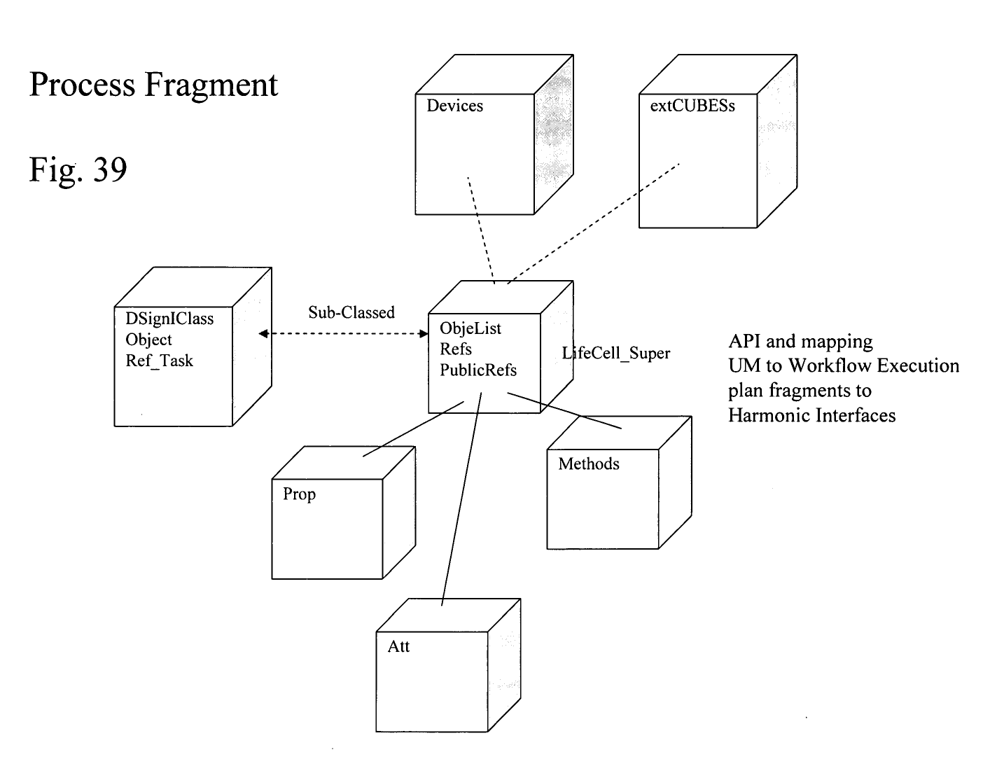

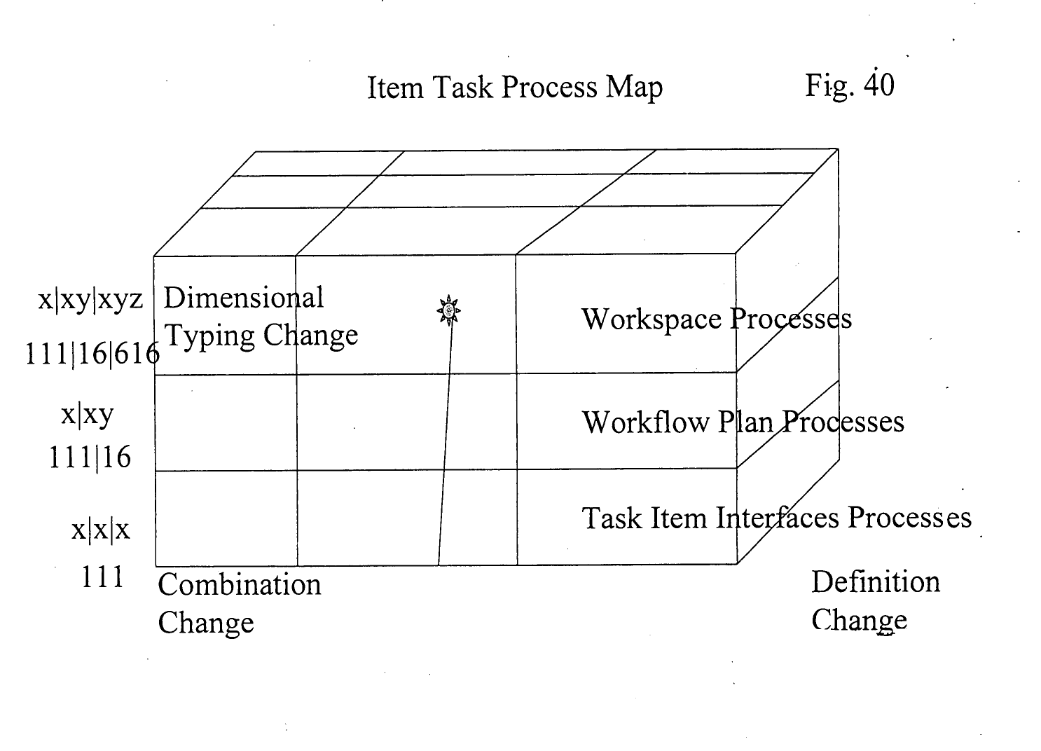

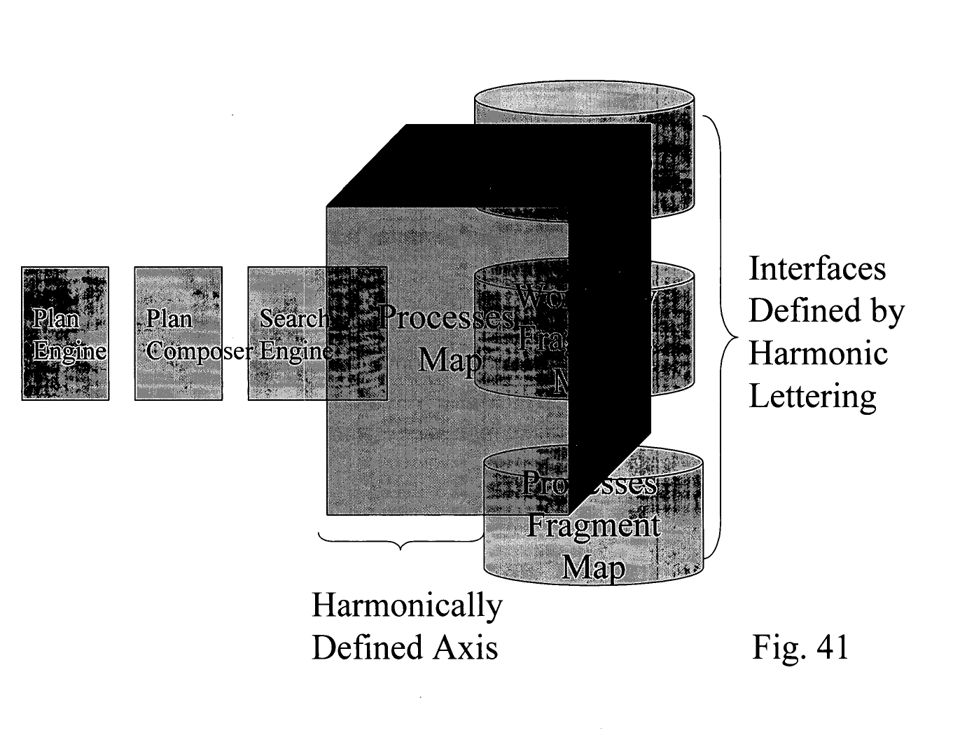

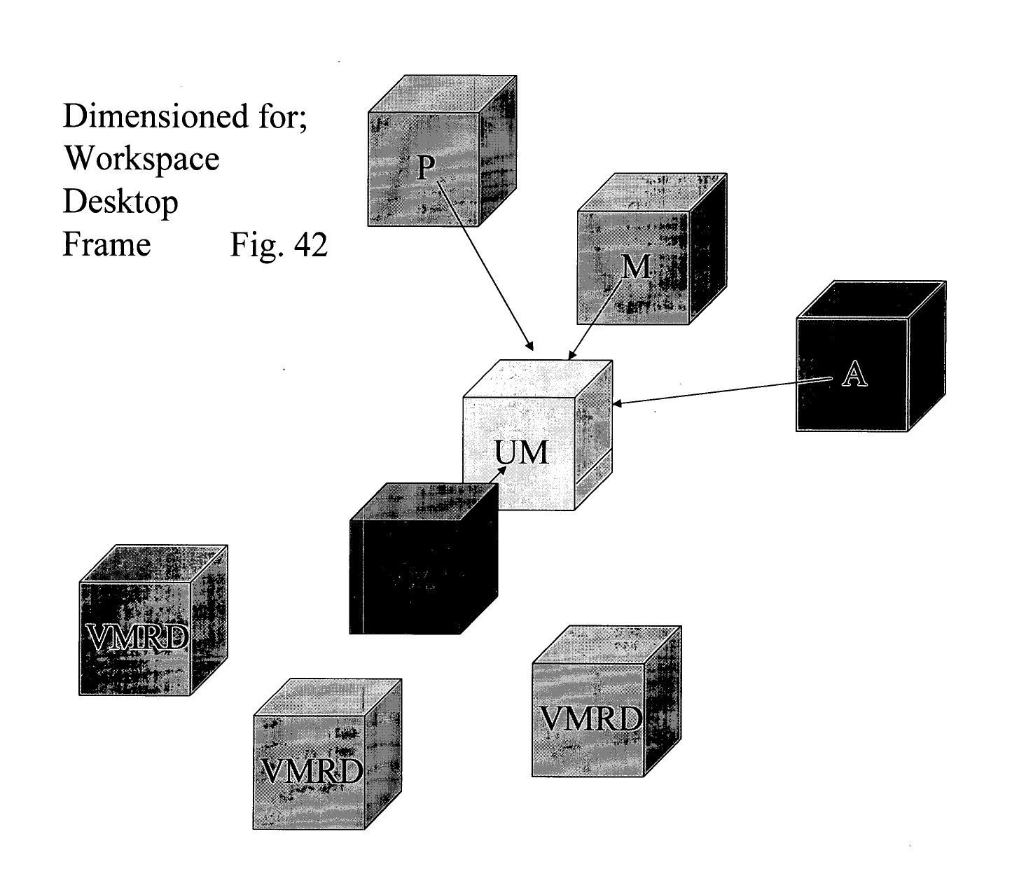

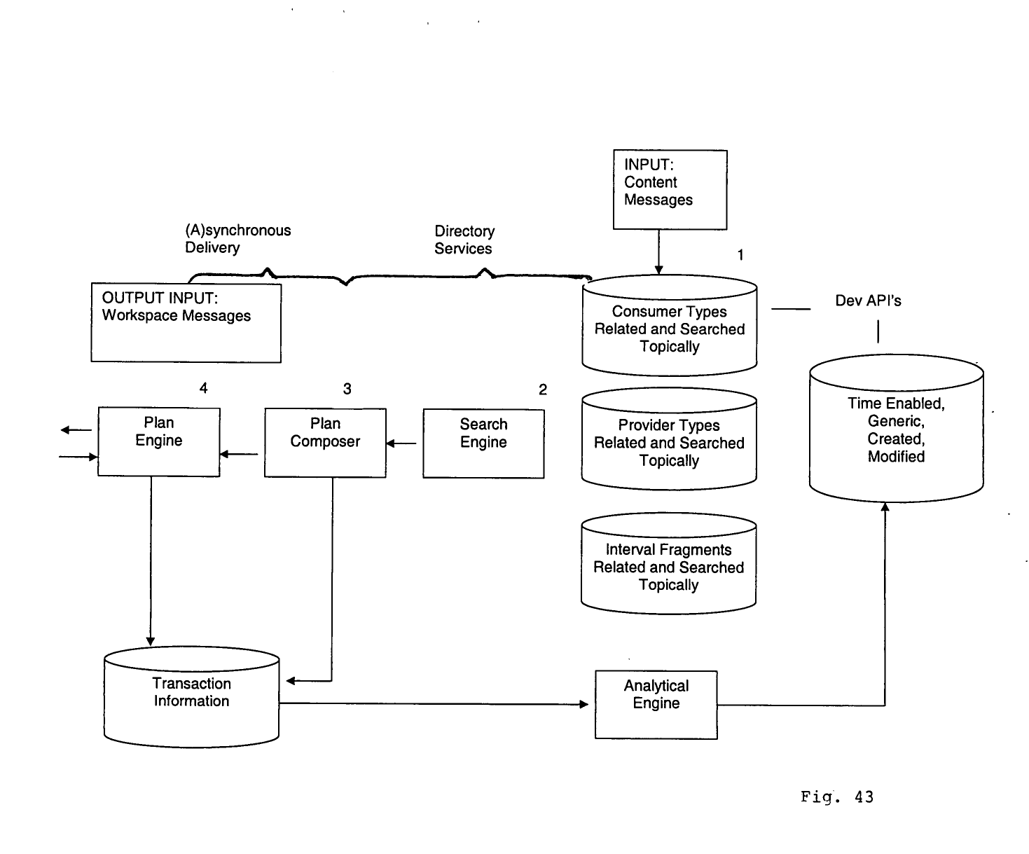

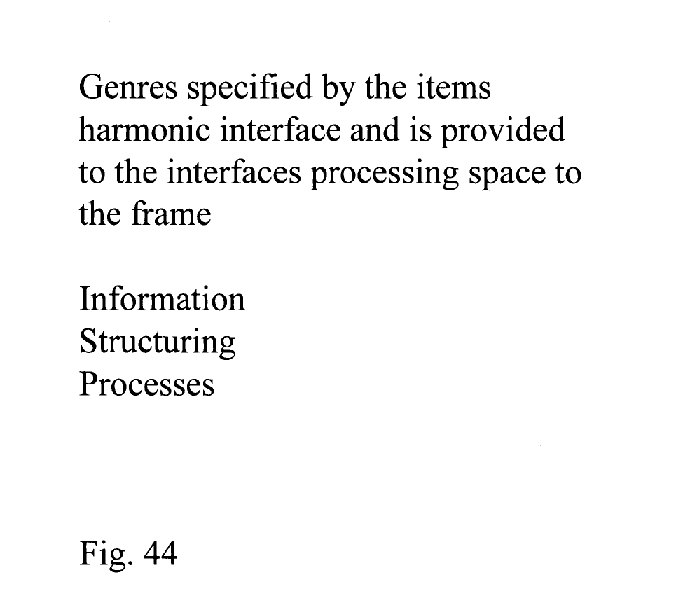

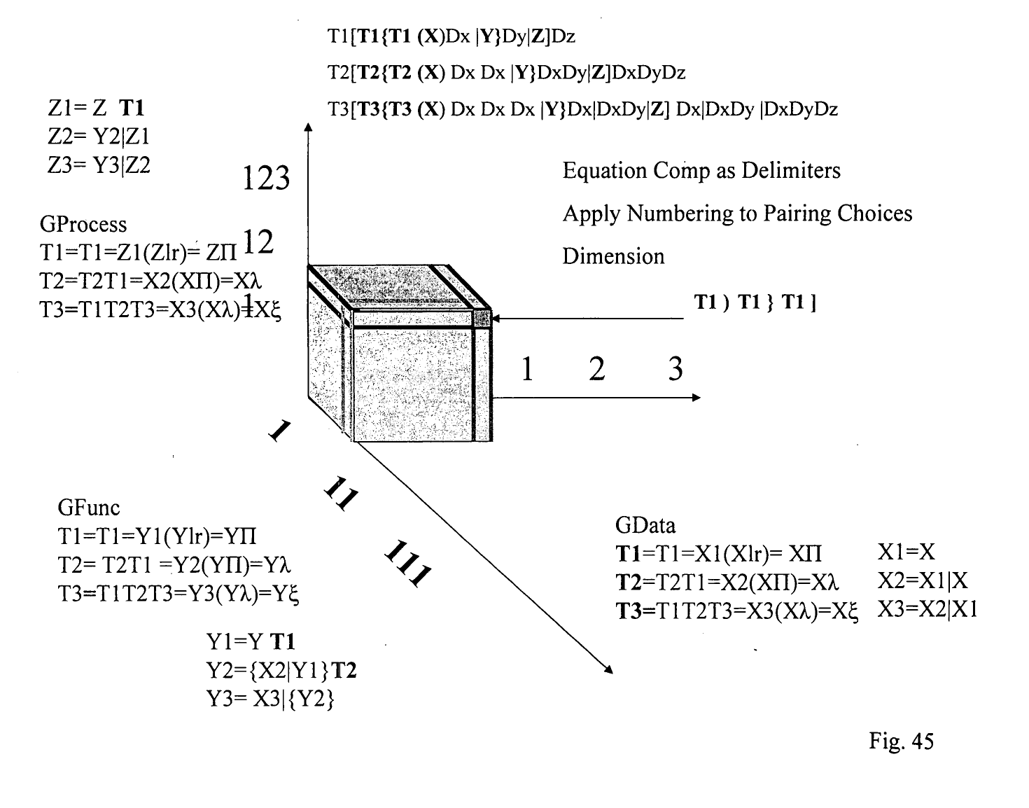

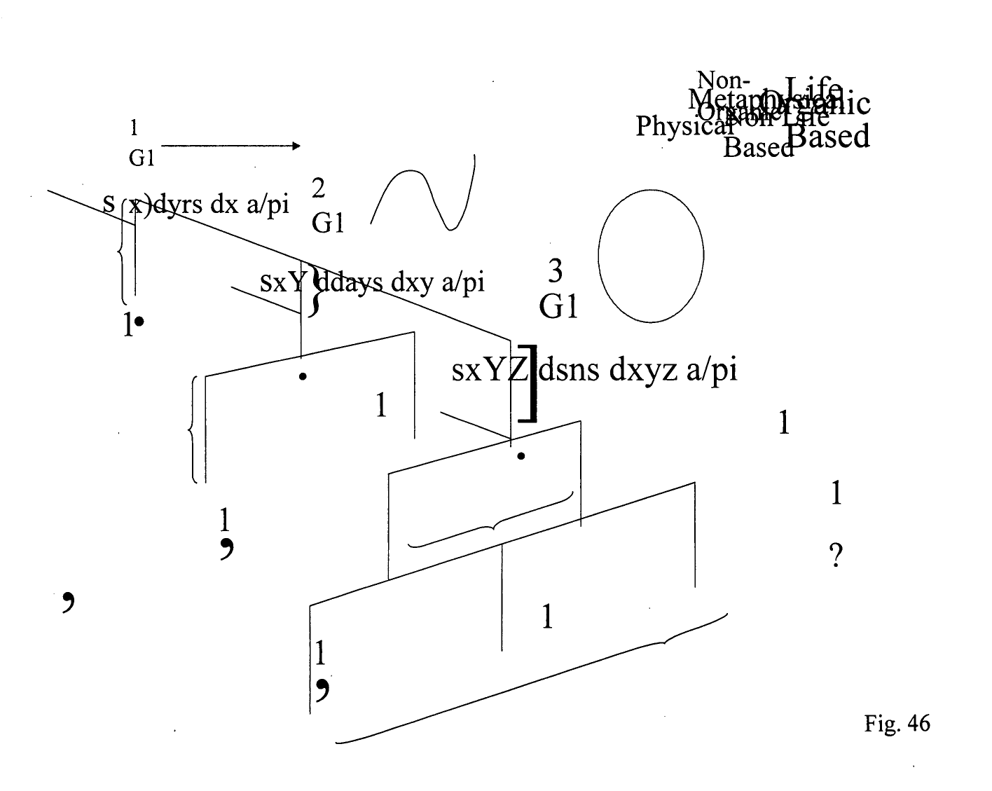

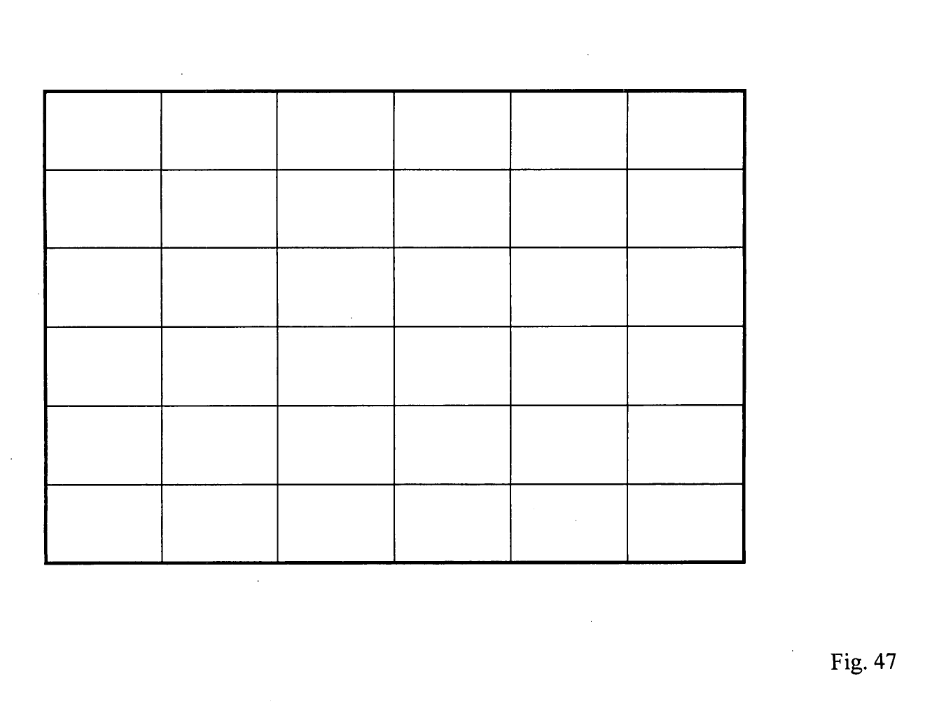

FIGS. 13 through 47 show alternative embodiments of the invention.

Source Code

The following appendix material presents some Omnis Studio source code that enables certain aspects of the invention. One of ordinary skill in the art can reproduce other features of the invention once being presented the points below. The compact disc appendix to the present application further enables all features of the invention.

Message parsing;

For count from 1 to 13 step 1

End For

Do method $cwind.$get_pan_left Returns pan_left

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

An embodiment of the present invention also relates to a new paradigm that of a recursive system type Universal Processing System Type and system defined harmonically and dimensionality expressed in the form of a generic schema definition for all life Definitions, Functions and Processes; and Process CUBE.mathematically defined by the equation;
[{(P1)gT|P2}gT gT|P3]gT gT gT

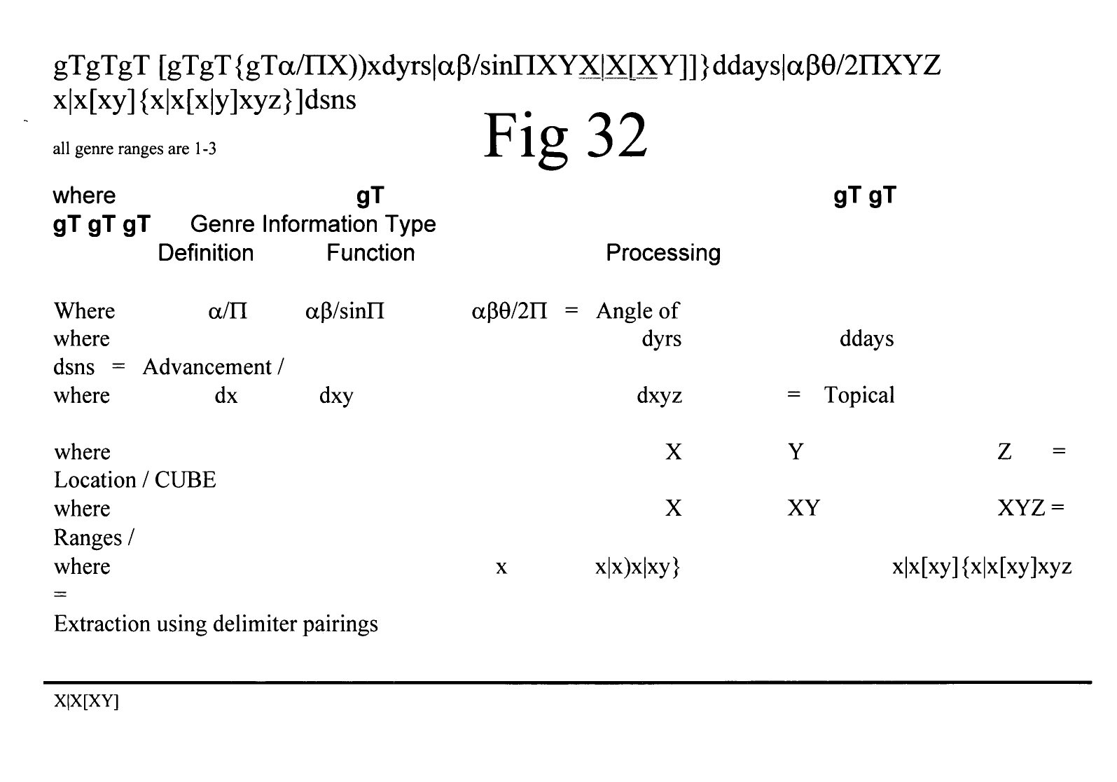

Represented in FIG. 32

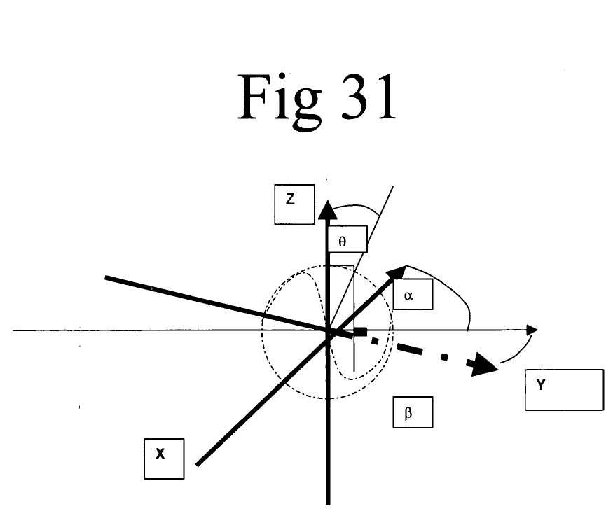

Represented in FIG. 31

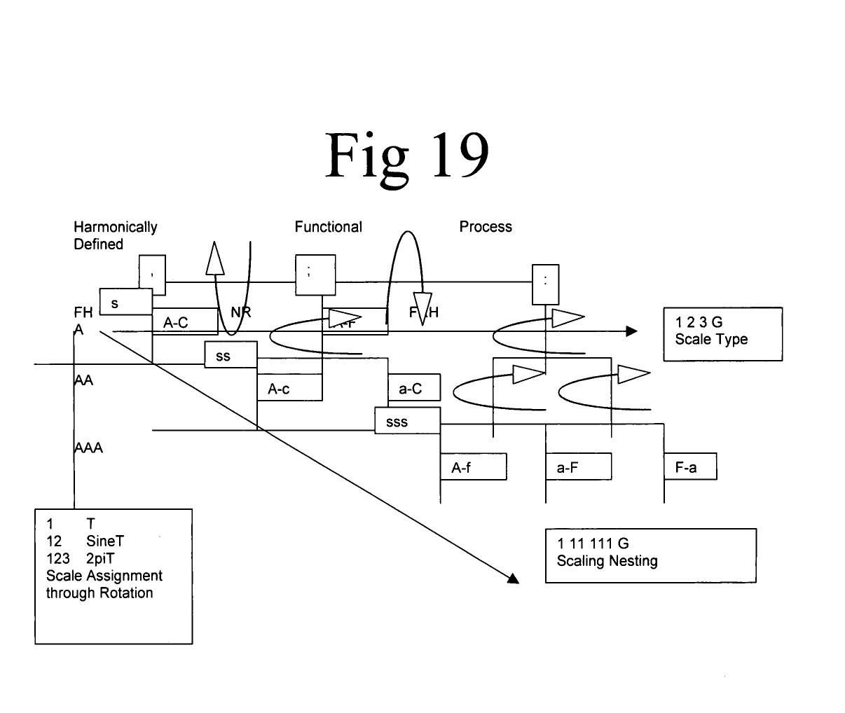

Universal Schema and Delimiter Pairings and Genre Scales FIG. 19

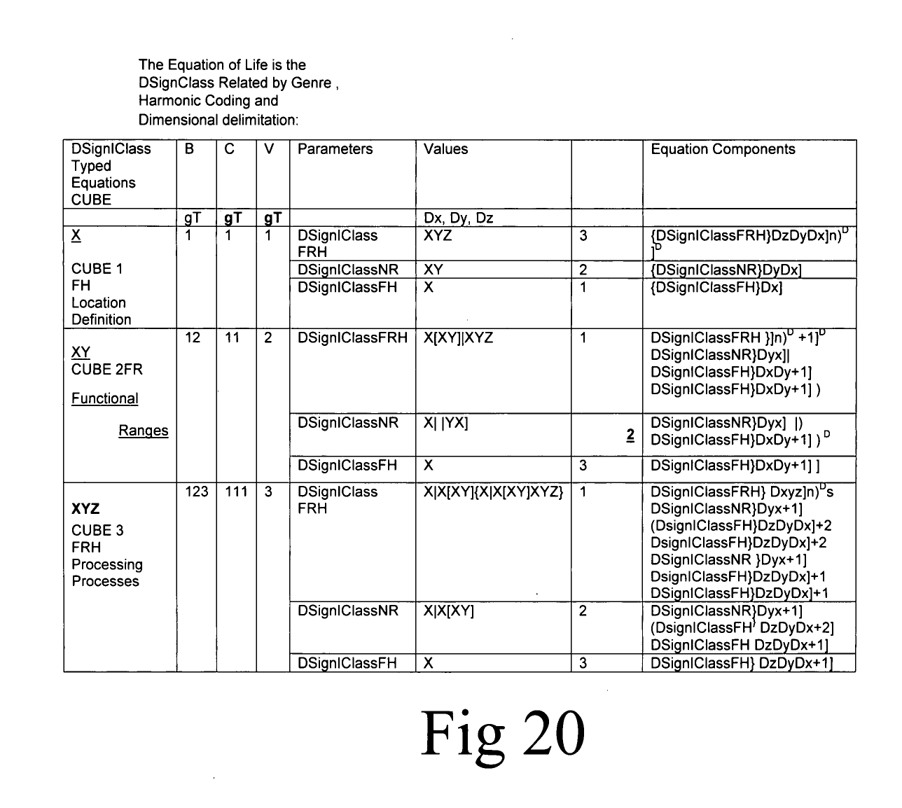

These relationships are represented by the DSignClass Structure; FIG. 20

Other embodiments of the present invention also preferably comprise and/or provide the following:

Virtual Mind comprising of CUBE creation, CUBE processing and reference via a Virtual Universal Map modules.

The system is fully reversible and can act as a Provider or Consumer of Harmonic Dimensioned Information expressing Processing, Functions and/or Definitions of any Type. Other embodiments of the present invention also preferably comprise and/or provide one or more of the following:

A remote process, user driven or self driven system remote CUBE presentation and execution device providing a client workspace supporting a plurality of CUBE execution platforms within a single workspace and a server based module providing dynamic CUBE creation, storage, and mapping services to the remote workspace.

Said delivery services between said client and said server modules is over TCP/IP and provides directory services, synchronous event, data and content transfer and multiple content specific communications and asynchronous messaging.

Said content can be specified by a XML document.

Said CUBE can be specified by a XML document.

Said content can be modified at run-time by said delivery services of claim 2 and said XML document of claim 3.

Said CUBE can be modified at run-time by said delivery services of claim 2 and said XML document of claim 3.

Said XML document can specify a multiplicity of content types, standard and custom properties, standard and custom behavior that can be specified by preferably selected from the group consisting of the list of types, properties events and behavior beginning on page 14 of the specification.

Said XML document can specify a multiplicity of CUBE types, standard and custom properties, standard and custom attributes and standard and custom methods that can be specified by preferably selected from the group consisting of the list of types, properties events and behavior beginning on page 19 of the specification

Said content types can be added to via an available developer application programming interface.

Said CUBE types can be added to via an available developer application programming interface or via the interface.

Said XML document can specify for said frames a plurality of display properties preferably one or more of the properties selected from the group consisting of Title Bar, Title Bar Text Alignment, Title Bar Text Font, Title Bar Text Font Size, Title Bar Text Font Style, Title Bar Text Color, Title Bar Height, Title Fore Color, Title Bar Gap Size, Title Bar Inner Border, Title Pattern, Title Back Color, Frame Inner Border, Frame Outer Border, Frame Gap Fill Color, Frame Gap Size, Frame Width, and Frame Height.

Said XML document can specify for CUBES Workflow level interface a plurality of dynamic properties relating to the presentation of the CUBEs processes preferably one or more of the properties selected from the group consisting of;

Said XML document can specify for said frames a plurality of behavioral properties preferably selected from the group consisting of Can Drag/Move, Can Resize, Disable Content Sizing, Bring to Top, Can Be Attached to a Form or Component, Edge Float, Minimizing, and Maximizing.

Said XML document can specify for said CUBES a plurality of behavioral attributes and methods preferably selected from the group consisting of Can Drag/Move, Can Resize, Disable Content Sizing, Bring to Top, Can Be Attached to a Form or Component, Edge Float, Minimizing, and Maximizing.

Said XML document can specify for said content, data access, and theme and data storage options.

Said XML document can specify for said CUBES, data access, and Genre or Information Typing and data storage options.

Said XML document can specify for said desktops a plurality of display, behavioral, dynamic and content specific properties preferably including one or more of the properties selected from the group consisting of Current Visible Desktop Number, Desktop Height, Desktop Width, Visible Desktop Area, Name, Fore Color, Border Color, Pattern, Border Effect, and Desktop Image.

Said XML document can specify for said CUBE execution platforms a plurality of display, behavioral, dynamic and Task execution platform specific properties preferably including one or more of the properties selected from the group consisting of Visible Task, Task Processing Resources, Visible Components Workflows, Name, Process Typing attributes.

Said desktops visible desktop area viewable by the browser may be changed.

The system of claim 1 wherein said Task Processing Resources may be changed dynamically at run time.

Said desktops are displayed in said window according to a front and back order wherein a desktop towards the front in the order overlaps any desktops farther back in the order, and wherein said order may be altered.

Said Task Processing, can be viewed at run-time.

Said frames can be repositioned throughout said desktop layers.

Said CUBES target processing position can be moved throughout said execution platforms at run-time.

Said frames' content may be populated asynchronously from server based content queues.

Said system may be populated asynchronously or synchronously from server based CUBE queues.

The system additionally comprising a set of services allowing said frames to exchange messages on the client.

The system additionally comprising a set of services allowing said devices to exchange messages on the remote workspace.

The system additionally comprising a set of services allowing presentation properties of groups of frames to be accessed as unit.

The system additionally comprising a set of services allowing execution properties of groups of CUBES to be accessed as unit.

The system wherein said workspace may be saved to said storage.

The system wherein said workspace may be saved to said storage.

The environment wherein desktops and said frames and their contents may be restored from a saved record.

The environment wherein execution platforms and said devices and their CUBES may be restored from a saved record.

What is claimed is:

1. A remote process or user driven system comprising of a browser based client module providing a client workspace comprising of a graphical user interface supporting a plurality of moveable frames and layered desktops within a single browser window and a server based module providing dynamic form based content creation, storage and delivery services to the client workspace.
